(19) United States
(12) Patent Application Publication
(10) Pub. No.: US 2019/0199814 A1
(43) Pub. Date: Jun. 27, 2019

(54) SERVER APPARATUS, CLIENT APPARATUS, METHOD OF CONTROLLING THE SAME, AND STORAGE MEDIUM

(71) Applicant: CANON KABUSHIKI KAISHA, Tokyo (JP)

(72) Inventors: Seiji Suzuki, Niigata-shi (JP); Tomoya Sakai, Kawasaki-shi (JP)

(21) Appl. No.: 16/292,117

(22) Filed: Mar. 4, 2019

Related U.S. Application Data
(63) Continuation of application No. PCT/JP2017/027452, filed on Jul. 28, 2017.

(30) Foreign Application Priority Data
Sep. 7, 2016 (JP) 2016-174967
Mar. 28, 2017 (JP) 2017-063750

(51) Int. Cl. H04L 29/08; H04L 29/06

(52) U.S. Cl. CPC H04L 67/26; H04L 67/42

(57) ABSTRACT

A server apparatus receives, from a client apparatus, a push transmission instruction concerning a media segment whose content data is divided, and push-transmits a media segment according to the received push transmission instruction to the client apparatus. The sever apparatus cancels, in a case in which a push cancel instruction including identification information used by the server apparatus to specify a media segment whose push transmission is to be canceled in media segments according to the received push transmission instruction is received from the client apparatus, push transmission of the media segment specified based on the identification information.

### CROSS-REFERENCE TO RELATED APPLICATIONS

This application is a Continuation of International Patent Application No. PCT/JP2017/027452, filed Jul. 28, 2017, which claims the benefit of Japanese Patent Application Nos. 2016-174967, filed Sep. 7, 2016, and 2017-063750, filed Mar. 28, 2017, which are hereby incorporated by reference herein in their entirety.

### BACKGROUND OF THE INVENTION

### Field of the Invention

The present invention relates to a server apparatus, a client apparatus, a method of controlling the same, and a storage medium and, more particularly, to a push technique of a content.

### Background Art

In recent years, there have been provided distribution systems each configured to distribute streaming type contents formed by audio data and video data to users in real time. Using such a distribution system, a user can enjoy a desired content such as a live video in real time via a terminal apparatus of his/her own.

As terminals such as smartphones and tablets become widespread, a demand to enjoy streaming contents anytime anywhere by various terminal apparatuses is increasing. To meet this requirement, methods (MPEG-DASH, Http Live Streaming, and the like) of dynamically changing a stream to be acquired in accordance with the capability of a terminal apparatus or the communication state of a terminal apparatus have received attention. DASH stands for Dynamic Adaptive Streaming over HTTP.

In these methods, video data is divided into segments of short time units, and a URL (Uniform Resource Locator) used to acquire the segments is described in a file called a playlist. A reception apparatus acquires the playlist first, and acquires desired video data using information described in the playlist. When URLs corresponding to video data segments of a plurality of versions are described in the playlist, the reception apparatus can acquire video data segments of an optimum version in accordance with its processing capability or communication environment.

These streaming methods have a function of PUSH (push)-transmitting a data segment from a transmission apparatus. Even when no request is received from the reception apparatus, a corresponding response can be transmitted by PUSH transmission before reception of the request. It is therefore possible to reduce a reproduction delay of a video.

PTL 1 describes an arrangement for quickly switching a medium by distributing the medium using PUSH transmission in response to a medium switching request in medium distribution using MPEG-DASH.

### CITATION LIST

### Patent Literature

PTL 1: Japanese Patent Laid-Open No. 2016-15534

According to the conventional arrangement, however, a mechanism configured to cancel PUSH transmission of an untransmitted segment from the reception side is not provided in a general system for PUSH-transmitting content data divided into segments. For this reason, in the conventional arrangement, transactions performed between the transmission apparatus and the reception apparatus to cancel PUSH transmission increase. For example, transactions increase when canceling PUSH transmission of some of segments of PUSH transmission targets or when canceling a specific PUSH reservation in a case in which PUSH transmission is reserved based on a plurality of PUSH transmission instructions.

### SUMMARY OF INVENTION

An aspect of the present invention provides a technique of canceling a reservation concerning push transmission by a small number of transactions.

A server apparatus according to an aspect of the present invention has the following arrangement. That is, there is provided a server apparatus comprising: a reception unit configured to receive, from a client apparatus, a push transmission instruction concerning a media segment whose content data is divided; a transmission unit configured to push-transmit a media segment according to the push transmission instruction received by the reception unit to the client apparatus; and a control unit configured to, in a case in which a push cancel instruction including identification information used by the server apparatus to specify a media segment whose push transmission by the transmission unit is to be canceled in media segments according to the push transmission instruction received by the reception unit is received from the client apparatus, cancel push transmission of the media segment specified based on the identification information by the transmission unit.

Further features of the present invention will become apparent from the following description of exemplary embodiments with reference to the attached drawings.

### BRIEF DESCRIPTION OF THE DRAWINGS

FIG. 1 is a view showing the system arrangement of a communication system;

FIG. 2 is a block diagram showing an example of the functional arrangement of a transmission apparatus;

FIG. 3 is a block diagram showing an example of the functional arrangement of a reception apparatus;

FIG. 4 is a block diagram showing an example of the hardware arrangement of the transmission apparatus;

FIG. 5 is a block diagram showing an example of the hardware arrangement of the reception apparatus;

FIG. 6 is a flowchart showing the operation procedure of the transmission apparatus;

FIG. 7 is a flowchart showing the operation procedure of the reception apparatus;

FIG. 8A is a view showing an example of a cancel method;

FIG. 8B is a view showing an example of a cancel method;

FIG. 9A is a view showing an example of a cancel method;

FIG. 9B is a view showing an example of a cancel method;

FIG. 10A is a view showing an example of a cancel method;

FIG. 10B is a view showing an example of a cancel method;

FIG. 11A is a view showing an example of a cancel method;

FIG. 11B is a view showing an example of a cancel method;

FIG. 11C is a view showing an example of a cancel method;

FIG. 12A is a view showing an example of a cancel method;

FIG. 12B is a view showing an example of a cancel method;

FIG. 12C is a view showing an example of a cancel method;

FIG. 13A is a view showing an example of a cancel method;

FIG. 13B is a view showing an example of a cancel method;

FIG. 13C is a view showing an example of a cancel method;

FIG. 14A is a view showing an example of a cancel method;

FIG. 14B is a view showing an example of a cancel method;

FIG. 15A is a view showing an example of a cancel method;

FIG. 15B is a view showing an example of a cancel method;

FIG. 15C is a view showing an example of a cancel method;

FIG. 16 is a view showing an example of a cancel method;

FIG. 17A is a view showing an example of a cancel method; and

FIG. 17B is a view showing an example of a cancel method.

### DESCRIPTION OF THE EMBODIMENTS

An embodiment of the present invention will now be described in detail with reference to the accompanying drawings. Arrangements to be described in the following embodiment are merely examples, and the present invention is not limited to detailed arrangement examples to be described below.

(Arrangement of Entire System)

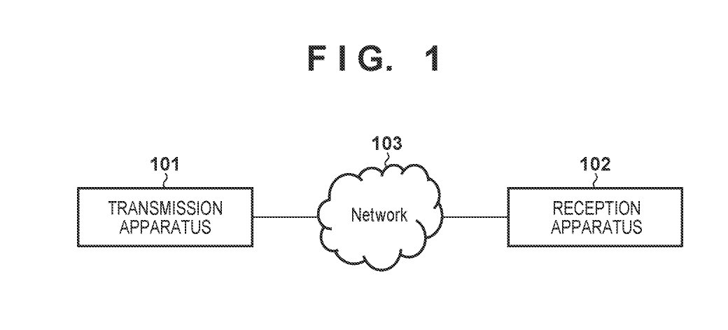

FIG. 1 is a view showing the overall arrangement of a communication system according to an embodiment of the present invention. A transmission apparatus 101 according to this embodiment is connected to a reception apparatus 102 via a network 103. Note that a plurality of transmission apparatuses 101 and a plurality of reception apparatuses 102 may exist. The transmission apparatus 101 is, for example, a server apparatus, and the reception apparatus 102 is, for example, a client apparatus.

The transmission apparatus 101 has a content transmission function of push-transmitting content data divided into segments to the reception apparatus 102. Note that the segments include an initial segment (initialization segment) describing a parameter used to reproduce a content and a medium segment describing content data. The transmission apparatus 101 may further have a function of accepting an input from a user. Detailed examples of the transmission apparatus 101 are information processing apparatuses such as a camera apparatus, a video camera apparatus, a smartphone apparatus, a PC (Personal Computer) apparatus, and a portable telephone. However, the present invention is not limited to this, and any transmission apparatus having the above-described functions can be used.

The reception apparatus 102 has a content reproduction/display function and a communication function, and receives the segments of content data push-transmitted from the transmission apparatus 101. The reception apparatus 102 may further have a function of accepting an input from a user. Detailed examples of the reception apparatus 102 are information processing apparatuses such as a smartphone apparatus, a PC apparatus, a TV set, and a portable telephone. However, the present invention is not limited to this, and any reception apparatus having the above-described functional arrangement can be used.

The network 103 is a wired LAN (Local Area Network) or a wireless LAN serving as a network in this embodiment. Note that in this embodiment, a wired LAN or a wireless LAN is used as the network 103. However, the present invention is not limited to this, and the network may be a WAN (Wide Area Network) or a PAN (Personal Area Network). In addition, the network 103 may use a public communication network such as the Internet.

(Functional Arrangement of Transmission Apparatus)

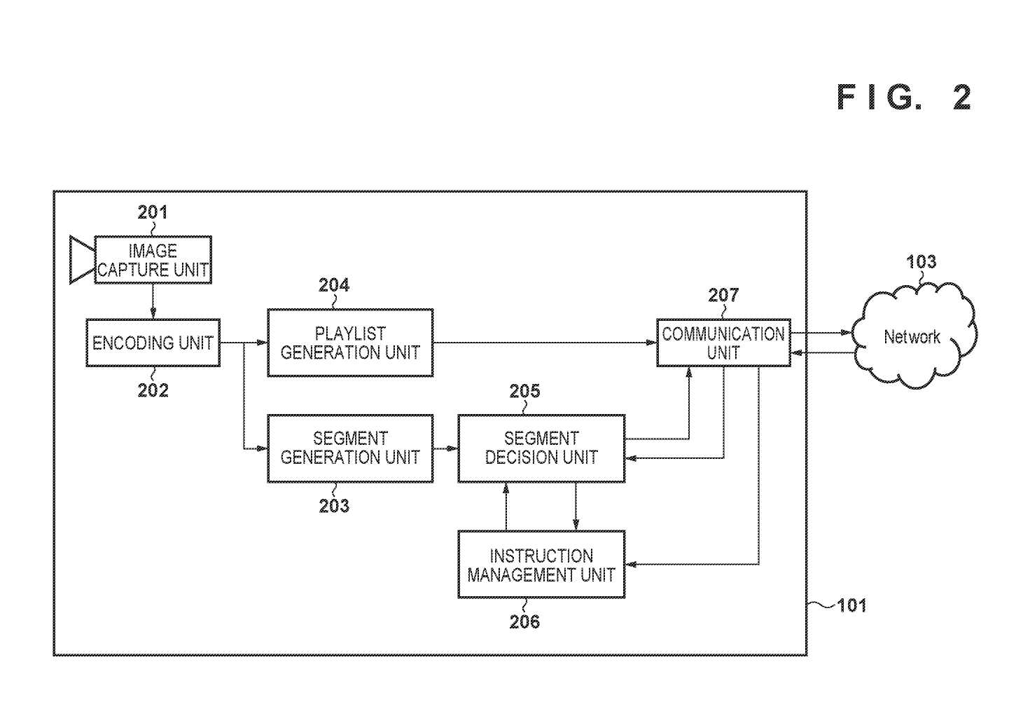

FIG. 2 is a block diagram showing an example of the functional arrangement of the transmission apparatus according to this embodiment. The transmission apparatus 101 according to this embodiment includes an image capture unit 201, an encoding unit 202, a segment generation unit 203, a playlist generation unit 204, a segment decision unit 205, an instruction management unit 206, and a communication unit 207.

The image capture unit 201 captures an image capture target and acquires video data. The encoding unit 202 encodes the video data captured by the image capture unit 201. Note that the image capture unit 201 and the encoding unit 202 may exist outside the transmission apparatus 101, and encoded video data may be provided to the transmission apparatus 101. Additionally, in this embodiment, the video data is data including not only a moving image but also an audio. Note that a content to be transmitted/received may be not only such video data but also a still image, an image including text data, or an image including a program code such as Javascript® executed in the reception apparatus 102.

The segment generation unit 203 generates a segment that is the transmission unit of video data from the video data encoded by the encoding unit 202. The segment is a unit of video data obtained by spatially or temporally dividing video data. An example in which ISOBMFF (Base Media File Format) is used as the file format of the segment according to this embodiment will be described. However, the present invention is not limited to this, and MPEG2TS or the like may be used. The playlist generation unit 204 generates a playlist in which a URL that enables access to the segments generated by the segment generation unit 203 is described. As the format of the playlist, MPD (Media Presentation Description) defined by MPEG-DASH exists. However, the present invention is not limited to this, and a format having the same function as the MPD, for example, a playlist description method in Http Livestreaming may be used.

The communication unit 207 transmits the generated playlist and segments to the reception apparatus 102 via the network 103 in response to a request from the reception apparatus 102. The instruction management unit (PUSH transmission instruction management unit) 206 holds a PUSH transmission instruction that the communication unit 207 has received from the reception apparatus 102 and also transmits the contents of the PUSH (push) transmission instruction to the segment decision unit 205. The segment decision unit (transmission segment decision unit) 205 decides segments to be transmitted when the communication unit 207 receives a segment acquisition request. In addition, based on the contents of the PUSH transmission instruction received from the instruction management unit 206, the segment decision unit 205 decides segments to be PUSH-transmitted.

(Functional Arrangement of Reception Apparatus)

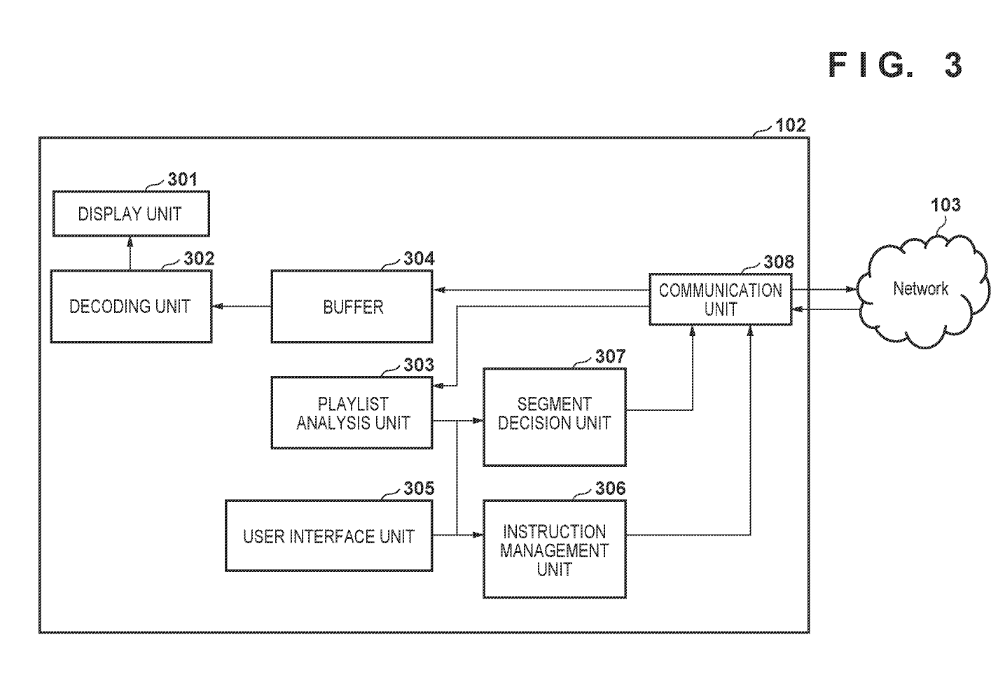

FIG. 3 is a block diagram showing the functional arrangement of the reception apparatus according to this embodiment. The reception apparatus 102 according to this embodiment includes a display unit 301, a decoding unit 302, a playlist analysis unit 303, a buffer 304, a user interface unit 305, an instruction management unit 306, a segment decision unit 307, and a communication unit 308.

The communication unit 308 receives segments and a playlist from the transmission apparatus 101 via the network 103, transfers the segments to the buffer 304, and transfers the playlist to the playlist analysis unit 303. The buffer 304 accumulates the segments transferred from the communication unit 308 and temporarily holds them. The decoding unit 302 decodes video data based on the segments accumulated in the buffer 304. The display unit 301 displays the reproduced image of the video data received from the transmission apparatus 101 via the network 103 and decoded by the decoding unit 302 or outputs an audio. Note that the display unit 301 may exist outside the reception apparatus 102, and may receive video data from the reception apparatus 102 and display it.

The playlist analysis unit 303 analyzes the playlist transferred from the communication unit 308. The user interface unit 305 displays a screen to be operated by the user on the display 508 to input an instruction from the user. For example, the user interface unit 305 displays a list of acquirable videos based on the playlist received from the transmission apparatus 101, and accepts selection from the user or accepts an instruction of pause or cancel reproduction.

Based on the input from the user interface unit 305, the segment decision unit (acquisition segment decision unit) 307 decides segments to be acquired based on the analysis result from the playlist analysis unit 303. However, the present invention is not limited to this, and another method of, for example, deciding a segment in accordance with the state of the network 103 may be used.

The instruction management unit (PUSH transmission instruction management unit) 306 transmits a PUSH transmission instruction via the communication unit 308 based on the analysis result from the playlist analysis unit 303, and manages the transmitted PUSH transmission instruction. However, the instruction management unit 306 may transmit the PUSH transmission instruction without referring to the analysis result of the playlist analysis unit 303 or may transmit the PUSH transmission instruction before acquisition of the playlist. The instruction management unit 306 transmits the PUSH transmission instruction based on the input from the user interface unit 305. However, the present invention is not limited to this, and another method of, for example, performing the transmission in accordance with the state of the network 103 may be used.

(Hardware Arrangement of Transmission Apparatus)

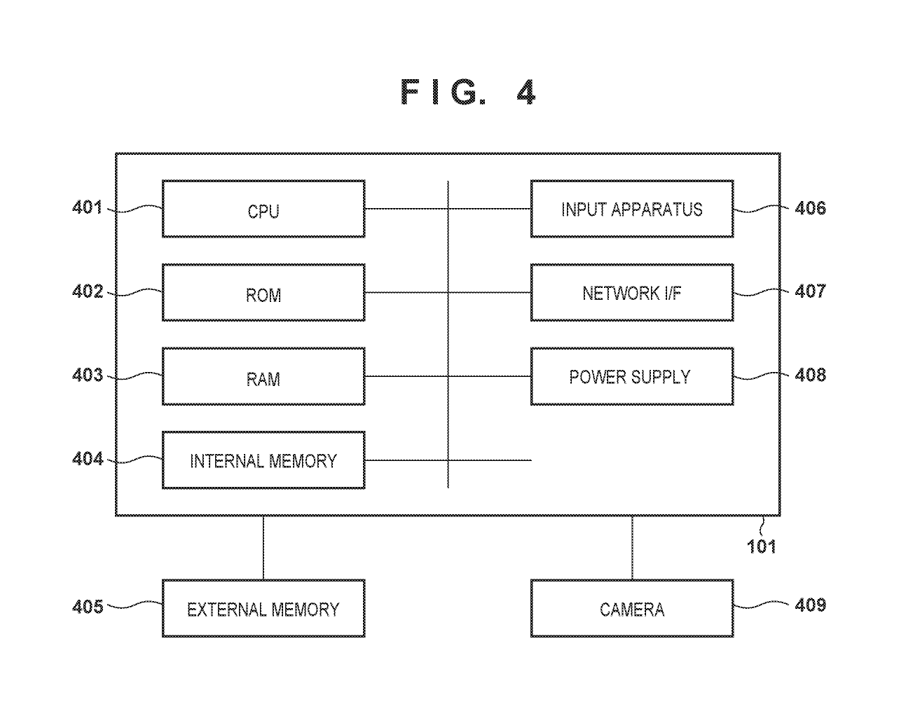

FIG. 4 is a block diagram showing an example of the hardware arrangement of the transmission apparatus 101 according to this embodiment. A central processing unit (to be referred to as a CPU hereinafter) 401 is a unit that controls the whole apparatus and calculates and processes data. The CPU 401 loads a computer program stored in a ROM 402 to be described later into a RAM 403 to be described later and executes it. In this embodiment, the CPU 401 controls the entire apparatus based on the computer program, thereby implementing the encoding unit 202, the segment generation unit 203, the playlist generation unit 204, the segment decision unit 205, and the instruction management unit 206.

The ROM 402 is a read only memory and is a storage device used to load information written once. In this embodiment, the ROM 402 stores the computer program of each functional unit shown in FIG. 2. The RAM 403 is a writable memory and is a storage device used to temporarily write and read data. The RAM 403 stores a temporary value of each program.

Each of an internal memory 404 and an external memory 405 is an external storage device that stores the contents of applications. The internal memory 404 is an incorporated storage device such as an SSD (Solid State Drive) or a hard disk. The external memory 405 is a detachable memory device such as a flash memory represented by a USB memory, an SD memory, or the like. Note that the computer programs configured to implement the functions shown in FIG. 2 may be stored not in the ROM 402 but in the RAM 403, the internal memory 404, or the external memory 405.

An input apparatus 406 is an apparatus that inputs an instruction from the user. The input apparatus 406 may implement a power button, a volume button, a home button, and the like by mechanical button switches, or may implement the buttons by a touch panel, a keyboard, a pointing device, or the like. A plurality of input apparatuses 406 can be implemented in the transmission apparatus 101.

A network I/F 407 is a device configured to transmit/receive data via the network 103. The network I/F 407 implements the communication unit 207. A power supply 408 is a device that supplies power to the transmission apparatus 101 and charges it, and includes a battery and a charging device. Note that the power supply 408 may be implemented by an AC adapter. A camera 409 is a device that captures a transmission content, and implements the image capture unit 201.

(Hardware Arrangement of Reception Apparatus)

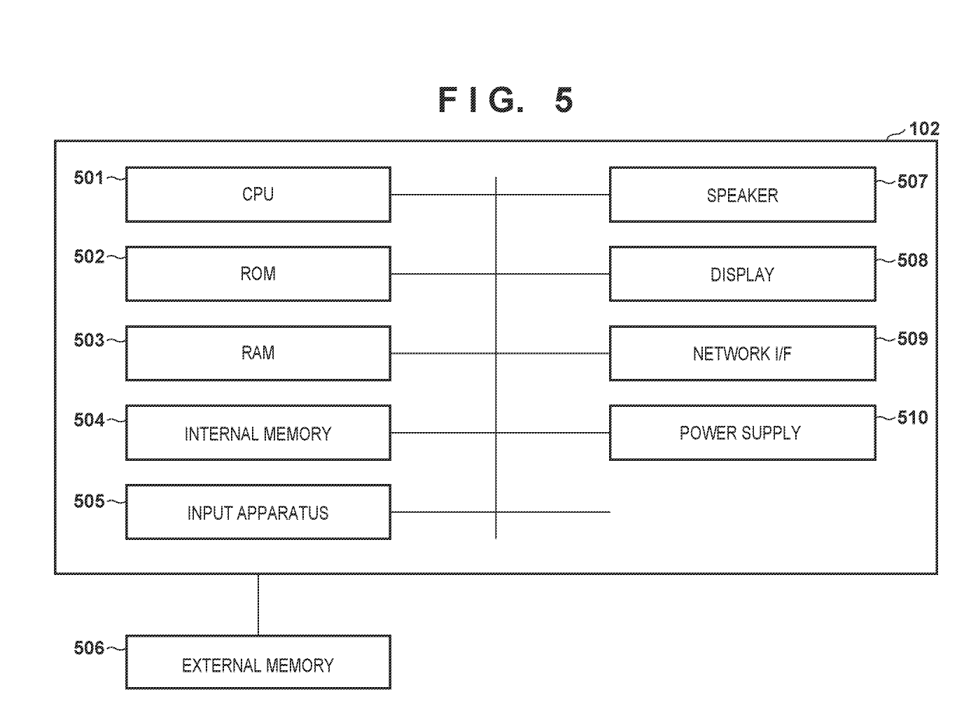

FIG. 5 is a block diagram showing an example of the hardware arrangement of the reception apparatus 102 according to this embodiment. A central processing unit (to be referred to as a CPU hereinafter) 501 is a unit that controls the whole apparatus and calculates and processes data. The CPU 501 loads a computer program stored in a ROM 502 to be described later into a RAM 503 to be described later and executes it. In this embodiment, the CPU 501 controls the entire apparatus based on the computer program, thereby implementing the decoding unit 302, the playlist analysis unit 303, the instruction management unit 306, and the segment decision unit 307.

The ROM 502 is a read only memory and is a storage device used to load information written once. In this embodiment, the ROM 502 stores the computer program of each functional unit shown in FIG. 3. The RAM 503 is a writable memory and is a storage device used to temporarily write and read data. The RAM 503 stores a temporary value of each program.

Each of an internal memory 504 and an external memory 506 is an external storage device that stores the contents of applications. These devices implement the buffer 304. Note that the buffer 304 may be implemented by the RAM 503. Detailed device examples of the internal memory 504 and the external memory 506 are the same as those of the internal memory 404 and the external memory 405 of the transmission apparatus 101 described with reference to FIG. 4.

An input apparatus 505 is an apparatus that inputs an instruction from the user. The input apparatus 505 may implement a power button, a volume button, a home button, and the like by mechanical button switches, or may implement the buttons by a touch panel, a keyboard, a pointing device, or the like. A plurality of input apparatuses 505 can be implemented in the reception apparatus 102. The input apparatus 505 implements the user interface unit 305.

A speaker 507 and a display 508 are devices that reproduce a content received from the transmission apparatus 101, and implement the display unit 301. That is, the speaker 507 outputs audio data included in the received content as an audio. The display 508 displays moving image data included in the received content as an image. A network I/F 509 is a device configured to transmit/receive data via the network. The network I/F 509 is a device that implements the communication unit 308. A power supply 510 is a device that supplies power to the reception apparatus 102 and charges it, and includes a battery and a charging device. Note that the power supply 510 may be implemented by an AC adapter.

(Processing of Transmission Apparatus)

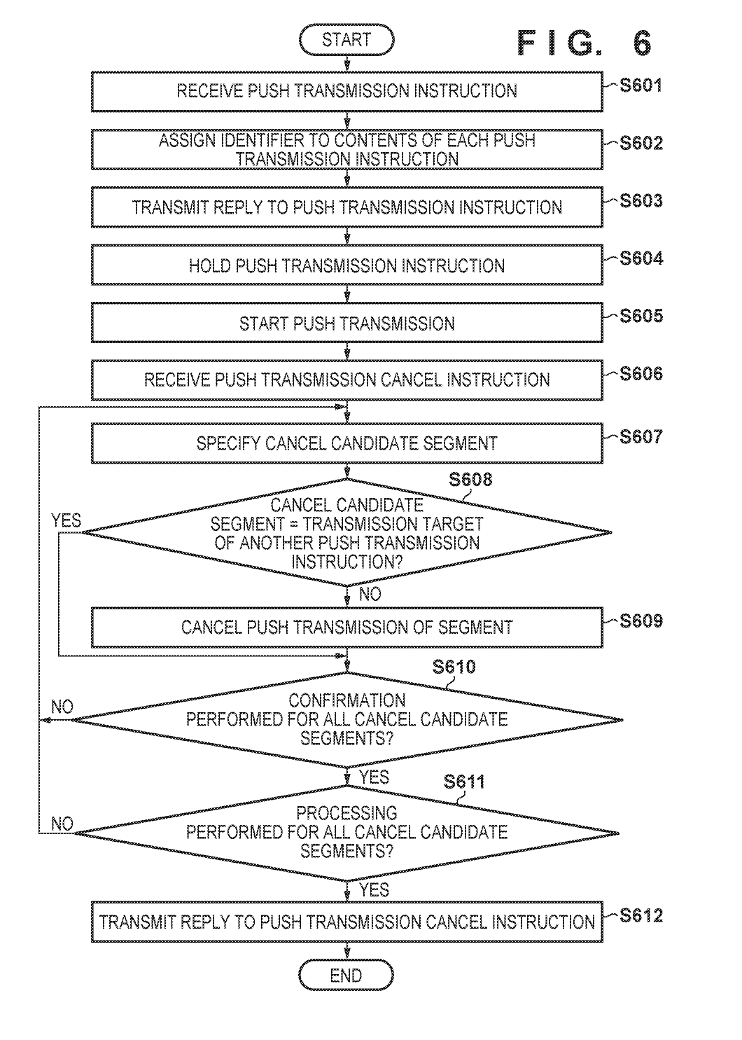

Processing of the transmission apparatus 101 according to this embodiment will be described with reference to FIG. 6. FIG. 6 is a flowchart showing the procedure of processing by the transmission apparatus 101 according to this embodiment from reception of a PUSH transmission instruction up to cancel of PUSH transmission. The steps shown in FIG. 6 are executed by controlling, by the CPU 401, the transmission apparatus 101 based on the computer program.

In step S601, the communication unit 207 receives a PUSH transmission instruction from the reception apparatus 102. The PUSH transmission instruction received here may be one PUSH transmission instruction, or a plurality of PUSH transmission instructions may be received simultaneously.

In step S602, the instruction management unit 206 assigns, each received PUSH transmission instruction, an identifier used to discriminate the PUSH transmission instruction. The identifier may be a number or a character string, or may have a form like a URL (Uniform Resource Locator). Alternatively, a value representing a type of data of a segment such as a video or an audio may be used as the identifier. In a case in which the identifier is already assigned on the side of the reception apparatus 102, the instruction management unit 206 may skip step S602 and directly use the identifier assigned by the reception apparatus 102. In a case in which the type of data of a segment is used as the identifier, step S602 can be skipped because the identifier need not be assigned anew. In a case in which the PUSH transmission instruction is discriminated by an element other than the identifier, step S602 can also be skipped. The PUSH transmission instruction may be discriminated not only by the identifier but also by the time of transmission of the PUSH transmission instruction by the reception apparatus 102 or the time of transmission of a reply by the transmission apparatus 101 to the PUSH transmission instruction in step S603 to be described later. The discrimination may be done by the resource to acquire in addition to the PUSH transmission instruction by the reception apparatus 102. For example, in HTTP/2, the resource is a segment name that is GET when outputting the PUSH transmission instruction. In addition to these methods, a method capable of discriminately managing the PUSH transmission instructions may be executed.

In step S603, the communication unit 207 transmits a reply to the PUSH transmission instruction. In a case in which step S602 is executed or in a case in which the reception apparatus 102 assigns the identifier to the PUSH transmission instruction, that is, in a case in which the PUSH transmission instruction is discriminated by the identifier, a reply including the identifier is transmitted. If the PUSH transmission instruction is discriminated by a value other than the identifier, the communication unit 207 transmits a reply including the value necessary for the discrimination of the PUSH transmission instruction. Instead of including each value in the reply, the playlist generation unit 204 may describe each value in MPD, thereby making a notification to the reception apparatus 102.

In step S604, the instruction management unit 206 holds the received PUSH transmission instruction. In a case in which the PUSH transmission instruction is discriminated by the identifier, the PUSH transmission instruction and the identifier are held by linking them with each other. When the type of data of a segment is used as the identifier, and the type of data can be known from the segment name, step S604 may be skipped. If the PUSH transmission instruction is discriminated by a value other than the identifier, the PUSH transmission instruction and the value used to discriminate the PUSH transmission instruction are held by linking them with each other.

In step S605, based on the contents of the received PUSH transmission instruction, the segment decision unit 205 decides segments to be PUSH-transmitted, and notifies the instruction management unit 206 of the list of decided segments. After that, the communication unit 207 PUSH-transmits the target segments. In a case of live distribution, the segments of PUSH targets are PUSH-transmitted as soon as their generation is completed. Note that steps S603, S604, and S605 may be executed in an order different from that in the flowchart.

In step S606, the communication unit 207 receives a PUSH transmission cancel instruction from the reception apparatus 102. The PUSH transmission cancel instruction received here may aim at one PUSH transmission instruction or may aim at a plurality of PUSH transmission instructions. In addition, the PUSH transmission cancel instruction may have contents to instruct cancel of all segments scheduled to be PUSHed by the PUSH transmission instruction or may have contents to instruct cancel of only some of the segments to be PUSHed by the PUSH transmission instruction.

Next, in a case in which the PUSH cancel target is one PUSH transmission instruction, the processes of steps S607 to S610 are sequentially performed for each segment as a cancel candidate in the segments to be PUSH-transmitted based on the PUSH transmission instruction. The cancel candidate will be described later concerning the explanation of step S607. If a plurality of PUSH transmission instructions are PUSH cancel targets, the processes of steps S607 to S611 are performed for each PUSH transmission instruction. For example, assume that the targets of the PUSH transmission cancel instruction are PUSH transmission instructions A and B, the PUSH transmission instruction A has two cancel candidate segments, and the PUSH transmission instruction B has three cancel candidate segments. In this case, the processes of steps S607 to S611 are executed first for A that is one of the target PUSH transmission instructions. At this time, the processes of steps S607 to S610 are sequentially performed twice, that is, as many times as the number of cancel candidate segments. After that, the processes of steps S607 to S611 are executed for the PUSH transmission instruction B that is another cancel target. At this time, the processes of steps S607 to S610 are sequentially performed three times, that is, as many times as the number of cancel candidate segments. The processes of steps S607 to S610 for each segment may be performed in parallel for each PUSH transmission instruction of the cancel target.

In step S607, the instruction management unit 206 specifies one segment as a cancel candidate from segments to be PUSHed by one of the PUSH transmission instructions at which the PUSH transmission cancel instruction aims. For example, assume that segment 1, segment 2, and segment 3 are to be PUSH-transmitted by a PUSH transmission instruction. Also assume that the PUSH transmission cancel instruction requests to cancel all the segments. In this case, the cancel candidate segments are all the three segment 1, segment 2, and segment 3. In step S607, the instruction management unit 206 selects one (for example, segment 1) of them. On the other hand, if the PUSH transmission cancel instruction requests cancel of only the last one of the segments, the cancel candidate segment is only segment 3, and segment 3 is inevitably selected. Note that if the PUSH transmission cancel is instructed for a plurality of segments, and some of the segments are already transmitted or transmission-canceled, segments except the segments are set to the cancel candidate segments. For example, if the PUSH transmission cancel targets are three segments 1 to 3, segment 1 is already transmitted, and segment 2 is transmission-canceled, only segment 3 is the cancel candidate segment.

In step S608, the instruction management unit 206 confirms whether the cancel candidate segment specified in step S607 is not the PUSH transmission target of another PUSH transmission instruction. For example, assume that segment 1, segment 2, and segment 3 are to be PUSH-transmitted by a PUSH transmission instruction (to be referred to as “instruction 1” hereinafter). Also assume that one of the cancel candidate segments by the PUSH transmission cancel instruction is segment 3 in instruction 1. On the other hand, segments scheduled to be PUSH-transmitted by another PUSH transmission instruction (to be referred to as “instruction 2” hereinafter) are segment 3 and segment 4. In this case, since segment 3 is scheduled to be PUSH-transmitted by instruction 2, PUSH transmission of segment 3 must not be canceled in the processing of instruction 1. Note that if a PUSH transmission instruction other than the PUSH transmission instruction of the cancel target is not received from the reception apparatus 102, step S608 may be skipped, and the process may transition to step S609.

Upon determining in step S608 that the cancel candidate segment specified in step S607 is not the PUSH transmission target of another PUSH transmission instruction (NO in step S608), the process transitions to step S609. Upon determining in step S608 that the cancel candidate segment specified in step S607 is the PUSH transmission target of another PUSH transmission instruction (YES in step S608), the process transitions to step S610.

In step S609, the instruction management unit 206 outputs, to the segment decision unit 205, an instruction to cancel PUSH transmission of the cancel candidate segment. Accordingly, the segment decision unit 205 cancels the PUSH transmission of the cancel candidate segment.

Checking whether cancel is possible and cancel processing in steps S608 and S609 are performed for all cancel candidate segments in the segments to be PUSH-transmitted by one PUSH transmission instruction. Hence, in step S610, it is determined whether the process of steps S608 and S609 are executed for all the cancel candidate segments of one PUSH transmission instruction of the processing target. Upon determining that the processes of steps S608 and S609 are executed for all the cancel candidate segments (YES in step S610), the process transitions to step S611. Upon determining in step S610 that the processes of steps S608 and S609 are not executed for all the cancel candidate segments (NO in step S610), the process transitions to step S607 to perform the above-described cancel processing for an unprocessed cancel candidate segment.

The processes of steps S607 to S610 are executed for each cancel candidate segment in the segments to be PUSH-transmitted by one PUSH transmission instruction. Note that all cancel candidate segments of all PUSH transmission instructions may be specified first in step S607, and steps S608 to S610 may then be executed for each of the specified cancel candidate segments.

In step S611, it is determined whether the processes of steps S607 to S610 are executed for all the PUSH transmission instructions that instruct cancel of PUSH transmission. Upon determining that the cancel processing in steps S607 to S610 is executed for all the PUSH transmission instructions of the cancel target (YES in step S611), the process transitions to step S612. Upon determining that the cancel processing in steps S607 to S610 is not executed for all the PUSH transmission instructions (NO in step S611), the process transitions to step S607 to perform the above-described cancel processing for an unprocessed PUSH transmission instruction.

The cancel method in steps S607 to S611 is not limited to the method described in the present invention. For example, another method of canceling PUSH transmission of a segment when the segment becomes the cancel candidate of a PUSH transmission instruction independently of whether the segment is the PUSH transmission target of another PUSH transmission instruction may be used.

In step S612, the communication unit 207 transmits a reply to the PUSH transmission cancel instruction to the reception apparatus 102.

(Processing of Reception Apparatus)

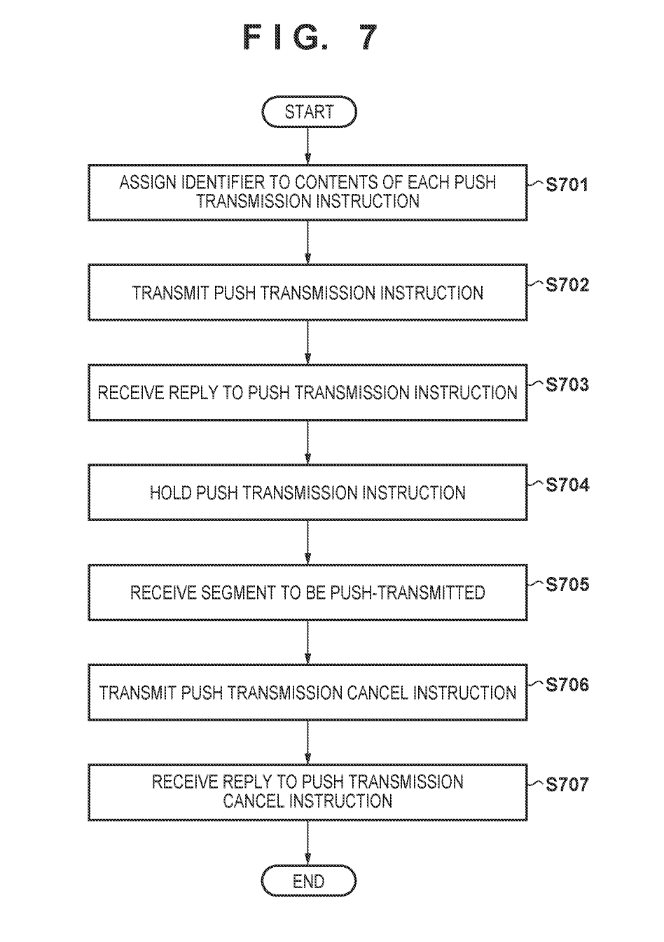

Processing of the reception apparatus 102 according to this embodiment will be described with reference to FIG. 7. FIG. 7 is a flowchart showing the procedure of processing by the reception apparatus 102 according to this embodiment from transmission of a PUSH transmission instruction up to subsequent cancel of PUSH transmission. The steps shown in FIG. 7 are executed by controlling, by the CPU 501, the reception apparatus 102 based on the computer program.

In step S701, the instruction management unit 306 assigns, to each PUSH transmission instruction to be transmitted, an identifier used to discriminate it. The identifier may be a number or a character string, or may have a form like a URL. Alternatively, a value representing a type of data of a segment such as a video or an audio may be used as the identifier. When the type of data of the segment is used as the identifier and the type of data can be known from the segment name, step S701 may be skipped. The identifier may be assigned by the transmission apparatus 101. In this case, step S701 can be skipped. If the PUSH transmission instruction is discriminated by a value other than the identifier, step S701 can be skipped.

In step S702, the communication unit 308 transmits the PUSH transmission instruction to the transmission apparatus 101. The PUSH transmission instruction transmitted here may be one PUSH transmission instruction, or a plurality of PUSH transmission instructions may be transmitted simultaneously. In a case in which the identifier is assigned in step S701, each PUSH transmission instruction including the identifier is transmitted.

In step S703, the communication unit 308 receives a reply from the transmission apparatus 101 to the PUSH transmission instruction. The reply is transmitted from the transmission apparatus 101 in step S603 of FIG. 6.

In step S704, the instruction management unit 306 holds the reply received from the transmission apparatus 101 to the PUSH transmission instruction.

In step S705, the communication unit 308 receives segments PUSH-transmitted from the transmission apparatus 101. The received segments are accumulated in the buffer 304, decoded by the decoding unit 302, and displayed/output by the display unit 301.

In step S706, the communication unit 308 transmits a PUSH transmission cancel instruction. This step may be executed before the reception of the PUSH transmission segments in step S705. The transmitted PUSH transmission cancel instruction may aim at one PUSH transmission instruction or may aim at a plurality of PUSH transmission instructions. In addition, the PUSH transmission cancel instruction may have contents to instruct cancel of all segments scheduled to be PUSHed by the PUSH transmission instruction. Alternatively, the PUSH transmission cancel instruction may have contents to instruct cancel of only some of the segments to be PUSHed by the PUSH transmission instruction.

Note that the trigger of transmission of the PUSH transmission cancel instruction in step S706 may be an instruction of the user, may be a state change in the band of a communication path that connects the transmission apparatus 101 and the reception apparatus 102, or may be a change in the state of the transmission apparatus 101 and/or the reception apparatus 102. In addition, the PUSH transmission cancel instruction may be included in the header of a message from a web browser executed in the reception apparatus 102, or may be included in a message from an application different from the web browser.

In addition, the PUSH transmission cancel instruction transmitted by the communication unit 308 includes the designation of a PUSH transmission instruction. As described concerning the explanation of step S602, this designation may be implemented using the identifier assigned to the PUSH transmission instruction, or may be implemented using time information. As the time information, the time of transmission of the PUSH transmission instruction by the reception apparatus 102 may be used, the time of transmission of a response by the transmission apparatus 101 to the PUSH transmission instruction may be used, or another information concerning time may be used. In addition, the designation may be implemented based on information used to identify the type (video data, audio data, or data other than these) of data as the push transmission target of the PUSH transmission instruction.

Instead of designating a PUSH transmission instruction, the communication unit 308 may transmit a PUSH transmission cancel instruction that designates a medium segment as the push transmission target, as will be described later. In addition, a URL may be used to designate a PUSH transmission instruction or designate a medium segment. In this way, the communication unit 308 transmits a PUSH transmission cancel instruction including identification information (for example, the identifier of a PUSH transmission instruction, time information, data type, or a URL used to designate a PUSH transmission instruction or a medium segment) used by the transmission apparatus 101 to specify a medium segment whose push transmission should be canceled.

In step S707, the communication unit 308 receives a reply to the PUSH transmission cancel instruction. This reply is transmitted from the transmission apparatus 101 in step S612 of FIG. 6.

As described above, upon receiving, from the reception apparatus 102, a push transmission instruction used to instruct push transmission of at least one segment, the transmission apparatus 101 accordingly controls to push-transmit each segment to the reception apparatus 102. Upon receiving, from the reception apparatus 102, a cancel instruction including the designation of a push transmission instruction and used to cancel push transmission of a segment, the transmission apparatus 101 stops push transmission of an untransmitted segment based on the designated push transmission instruction. In this way, in this embodiment, a push transmission instruction is designated, and push transmission is canceled. This makes it possible to cancel push transmission by a minimum number of transactions independently of a communication protocol used such as HTTP/2 or Web Socket.

As described above, the designation of the push transmission instruction can be done by combining, for example, the identifier of the push transmission instruction or the contents of the push transmission instruction and a resource requested by the reception apparatus 102 or time concerning transmission/reception of the push transmission instruction. In addition, when the transmission apparatus 101 stops push transmission of all or some untransmitted segments in accordance with the contents of the received cancel instruction, the reception apparatus 102 can cancel the transmission of a desired segment later.

In addition, in a case in which a plurality of push transmission instructions are received, and segments are push-transmitted, if a cancel instruction is received for a push transmission instruction, the transmission apparatus 101 excludes the transmission targets of the remaining push transmission instructions from the cancel targets in step S608. That is, instead of stopping the transmission of all untransmitted segments based on the push transmission instruction designated by the cancel instruction, the transmission is stopped only for segments that are not included in the untransmitted segments based on the remaining push transmission instructions. It is therefore possible to prevent the occurrence of cancel unintended by the user of the reception apparatus 102 in push distribution of segments.

### Operation Example 1

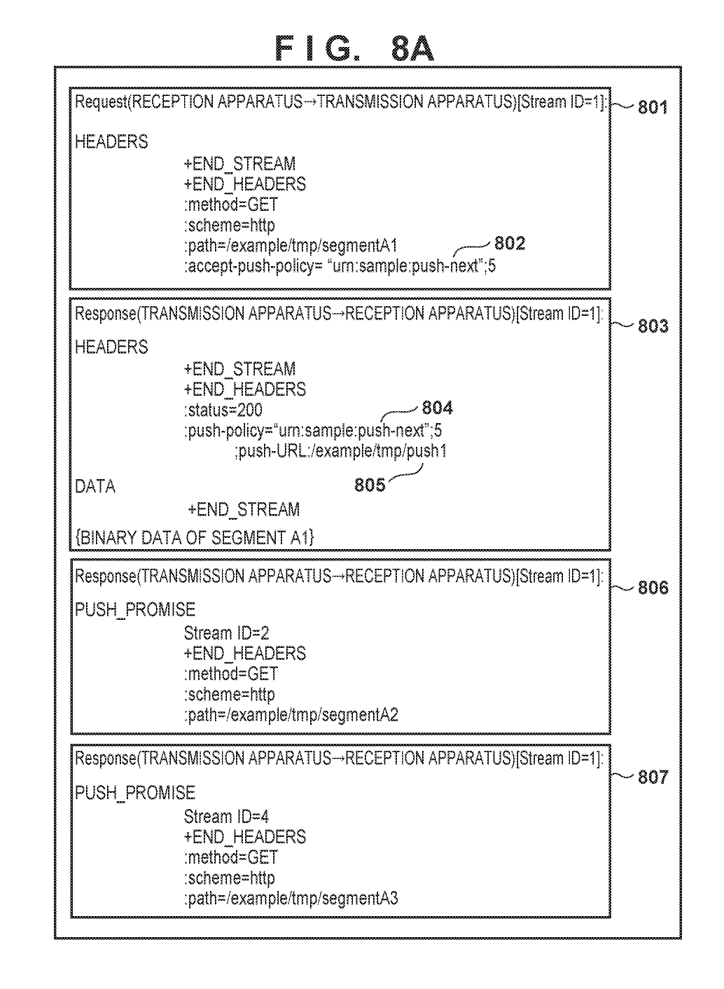

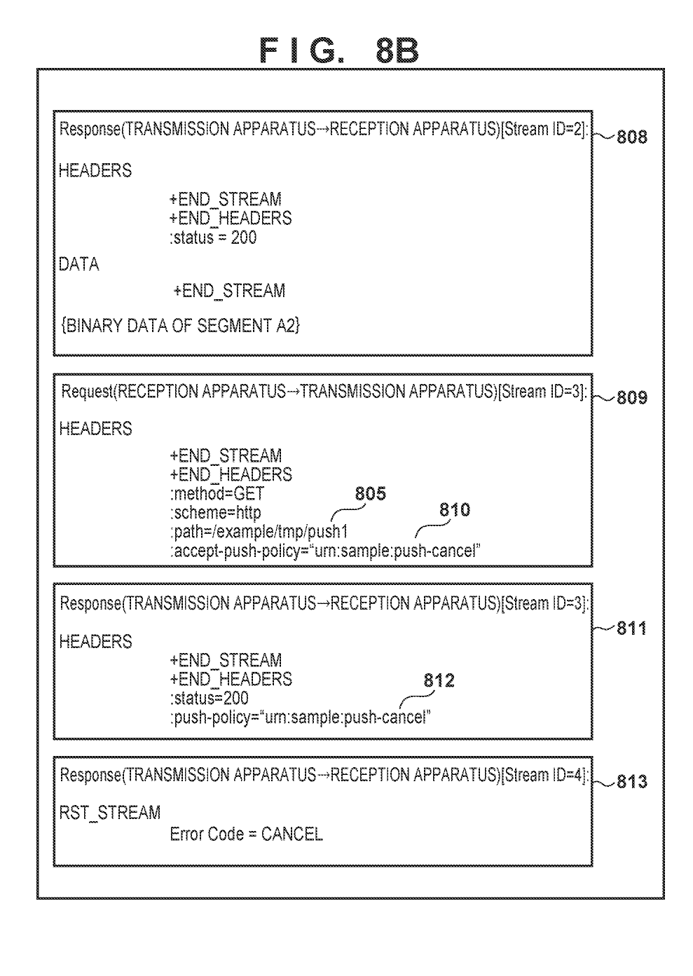

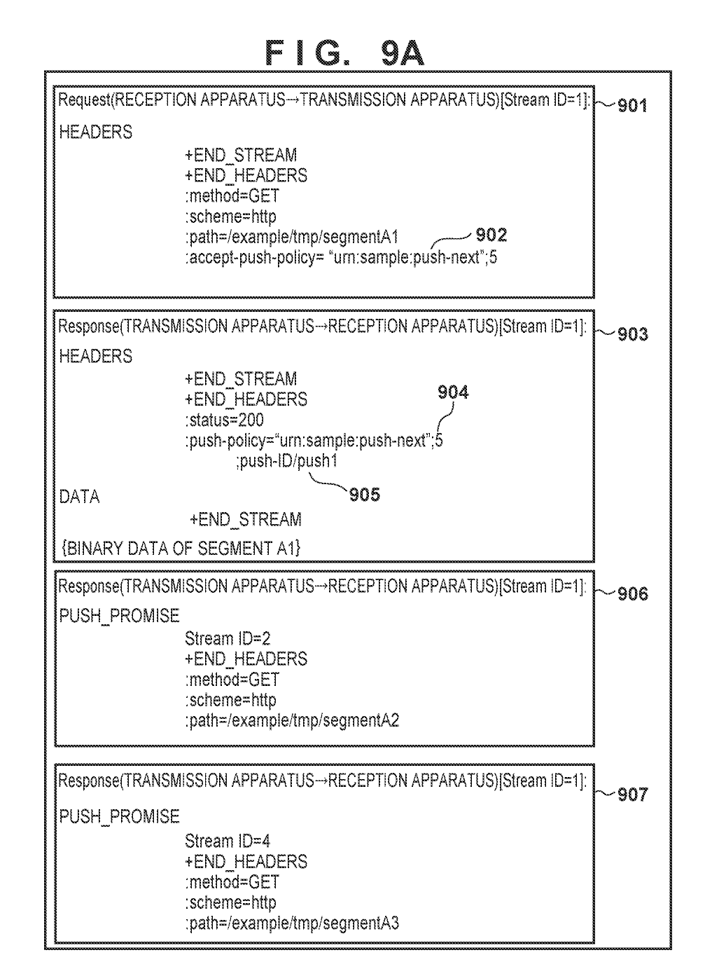

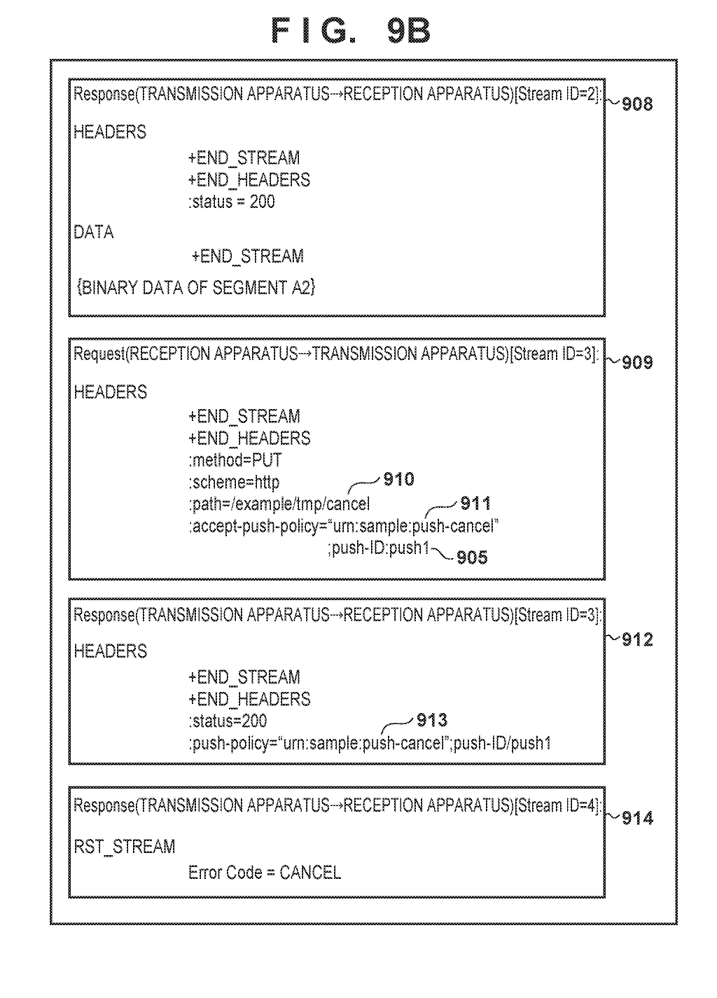

An example in which a PUSH transmission instruction to be canceled is designated by an identifier of URL form, and all segments scheduled to be PUSHed by the PUSH transmission instruction are canceled on HTTP/2 will be described with reference to FIGS. 8A and 8B. FIGS. 8A and 8B are schematic views showing an example of requests and response messages exchanged between the transmission apparatus 101 and the reception apparatus 102. Data transmitted from the reception apparatus 102 to the transmission apparatus 101 will be referred to as a request, and data transmitted from the transmission apparatus 101 to the reception apparatus 102 will be referred to as a response here. The messages are exchanged sequentially from a message on the upper side to a message on the lower side of FIG. 8A and then exchanged from a message on the upper side to a message on the lower side of FIG. 8B. That is, the messages are exchanged from a request 801 in the order of 803, 806, 807, 808, 809, 811, and 813. The same configuration applies to FIGS. 9A to 17B below. Here, an identifier is assigned by the transmission apparatus 101, and step S701 is skipped.

In step S702, the communication unit 308 of the reception apparatus 102 transmits the request 801 including a PUSH transmission instruction 802 in the accept-push-policy header to the transmission apparatus 101. The request 801 has contents to request a segment called segment A1. The request 801 further instructs, by the PUSH transmission instruction 802, to PUSH-transmit five segments A2 to A6 which continue from segment A1 in terms of reproduction time. In 802, a number “5” next to “urn:sample:push-next” designates the number of segments to be acquired next to “/example/tmp/segmentA1”. In step S601, the communication unit 207 of the transmission apparatus 101 receives the request 801 including the PUSH transmission instruction 802.

In step S602, the instruction management unit 206 of the transmission apparatus 101 assigns an identifier 805 “/example/tmp/push1” to the received PUSH transmission instruction 802. In Operation Example 1, the identifier employs the form of a URL.

In step S603, the communication unit 207 of the transmission apparatus 101 transmits, to the reception apparatus 102, the response 803 that includes, in the push-policy header, a reply 804 of a PUSH transmission instruction having the same contents as the PUSH transmission instruction 802 as the reply to the PUSH transmission instruction 802. The push-policy header of the response 803 also includes the identifier 805 in correspondence with the reply 804 of the PUSH transmission instruction. When a prefix “push-URL” is placed before the identifier 805, the point of the push-policy header at which the identifier 805 starts can be known. The prefix is not limited to “push-URL”. Instead of transmitting the identifier 805 together with the reply 804 of the PUSH transmission instruction, the transmission apparatus 101 may describe the identifier 805 in MPD and notify the reception apparatus 102 of it.

After transmission of the response 803, the transmission apparatus 101 transmits the PUSH_PROMISEs 806 and 807 used to reserve streams to be used to transmit segment A2 and segment A3 scheduled to be PUSH-transmitted on HTTP/2. Accordingly, the reception apparatus 102 receives them. In the example shown in FIGS. 8A and 8B, a stream of Stream ID=2 is reserved for segment A2, and a stream of Stream ID=4 is reserved for segment A3. Note that the PUSH_PROMISEs 806 and 807 may be transmitted before the response 803. PUSH_PROMISEs corresponding to the segments (segment A4, segment A5, and segment A6) after segment A3 are not transmitted. In HTTP/2, the PUSH_PROMISEs are not transmitted in a case in which, for example, generation of a segment involved is not completed, or the upper limit of the number of segments that can simultaneously be reserved for transmission is reached. Transmission of PUSH_PROMISEs may be inhibited even in other cases.

In step S604, the instruction management unit 206 of the transmission apparatus 101 holds the received PUSH transmission instruction 802 and the identifier 805 by linking them with each other.

In step S703, the communication unit 308 of the reception apparatus 102 receives the response 803 including the reply 804 of the PUSH transmission instruction 802 and the binary data of segment A1. Additionally, in step S704, the instruction management unit 306 of the reception apparatus 102 holds the PUSH transmission instruction 802 accepted by the transmission apparatus 101 by linking it with the identifier 805.

In step S605, the transmission apparatus 101 starts PUSH transmission, and the communication unit 207 of the transmission apparatus 101 transmits the response 808 to the reception apparatus 102 as the PUSH transmission of segment A2. In this embodiment, if the numerical values at the end of the names of segments continue, the segments are assumed to continue in terms of reproduction time. For example, the reproduction times of segment A2 and segment A3 continue, and the video at the end of segment A2 continues to the video at the start of segment A3.

In step S705, the communication unit 308 of the reception apparatus 102 receives the response 808 including the binary data of segment A2.

In step S706, the communication unit 308 of the reception apparatus 102 transmits the request 809 including a PUSH transmission cancel instruction 810 in the accept-push-policy header. The PUSH transmission cancel instruction 810 has contents to cancel all segments scheduled to be PUSH-transmitted by the PUSH transmission instruction 802. The PUSH transmission instruction 802 to be canceled is designated by designating the identifier 805 in the path header of the request 809. The identifier 805 may be included not in the path header but in the accept-push-policy header together with the prefix “push-URL”. The prefix is not limited to “push-URL”.

In step S606, the communication unit 207 of the transmission apparatus 101 receives the request 809 including the PUSH transmission cancel instruction 810.

In step S607, the instruction management unit 206 of the transmission apparatus 101 specifies, as a cancel candidate segment, segment A3 that is a segment scheduled to be PUSH-transmitted by the PUSH transmission instruction 802 that is the cancel target determined based on the identifier 805. In the example shown in FIGS. 8A and 8B, PUSH transmission of segment A2 to segment A6 is requested by the PUSH transmission instruction 802. Here, since segment A2 is already transmitted (808), segment A3 having the smallest serial number in the untransmitted segments is specified as the cancel candidate segment.

Since any PUSH transmission instruction other than the PUSH transmission instruction 802 is not instructed in the transmission apparatus 101, step S608 is skipped, and the process transitions to step S609.

In step S609, the instruction management unit 206 of the transmission apparatus 101 outputs, to the segment decision unit 205, an instruction to cancel PUSH transmission of segment A3, and the segment decision unit 205 cancels the PUSH transmission of segment A3. As detailed cancel processing, since the transmission is already reserved by the PUSH_PROMISE 807, transmission of the RST_STREAM 813 used to cancel the transmission reservation and processing of stopping PUSH transmission in the transmission apparatus 101 are performed.

In step S610, it is determined that confirming whether cancel is possible and cancel processing are not performed for all the cancel candidate segments of the PUSH transmission instruction 802 by the PUSH transmission cancel instruction 810 (NO in step S610), and the process transitions to step S607.

In step S607, the instruction management unit 206 of the transmission apparatus 101 specifies, as a cancel candidate segment, segment A4 that is a segment scheduled to be PUSH-transmitted by the PUSH transmission instruction 802 that is the cancel target determined based on the identifier 805.

Since any PUSH transmission instruction other than the PUSH transmission instruction 802 is not instructed in the transmission apparatus 101, step S608 is skipped, and the process transitions to step S609.

In step S609, the instruction management unit 206 of the transmission apparatus 101 outputs, to the segment decision unit 205, an instruction to cancel PUSH transmission of segment A4, and the segment decision unit 205 cancels the PUSH transmission of segment A4. As detailed cancel processing, only processing of stopping PUSH transmission in the transmission apparatus 101 is performed. Since transmission reservation of segment A4 is not performed, only the stop processing in the transmission apparatus 101 suffices.

In step S610, it is determined that confirming whether cancel is possible and cancel processing are not performed for all the cancel candidate segments of the PUSH transmission instruction 802 by the PUSH transmission cancel instruction 810 (NO in step S610), and the process transitions to step S607.

In step S607, the instruction management unit 206 of the transmission apparatus 101 specifies, as a cancel candidate segment, segment A5 that is a segment scheduled to be PUSH-transmitted by the PUSH transmission instruction 802 that is the cancel target determined based on the identifier 805.

Since any PUSH transmission instruction other than the PUSH transmission instruction 802 is not instructed in the transmission apparatus 101, step S608 is skipped, and the process transitions to step S609.

In step S609, the instruction management unit 206 of the transmission apparatus 101 outputs, to the segment decision unit 205, an instruction to cancel PUSH transmission of segment A5, and the segment decision unit 205 cancels the PUSH transmission of segment A5. As detailed cancel processing, only processing of stopping PUSH transmission in the transmission apparatus 101 is performed. Since transmission reservation of segment A5 is not performed, only the stop processing in the transmission apparatus 101 suffices.

In step S610, it is determined that confirming whether cancel is possible and cancel processing are not performed for all the cancel candidate segments of the PUSH transmission instruction 802 by the PUSH transmission cancel instruction 810 (NO in step S610), and the process transitions to step S607.

In step S607, the instruction management unit 206 of the transmission apparatus 101 specifies, as a cancel candidate segment, segment A6 that is a segment scheduled to be PUSH-transmitted by the PUSH transmission instruction 802 that is the cancel target determined based on the identifier 805.

Since any PUSH transmission instruction other than the PUSH transmission instruction 802 is not instructed in the transmission apparatus 101, step S608 is skipped, and the process transitions to step S609.

In step S609, the instruction management unit 206 of the transmission apparatus 101 outputs, to the segment decision unit 205, an instruction to cancel PUSH transmission of segment A6, and the segment decision unit 205 cancels the PUSH transmission of segment A6. As detailed cancel processing, only processing of stopping PUSH transmission in the transmission apparatus 101 is performed. Since transmission reservation of segment A6 is not performed, only the stop processing in the transmission apparatus 101 suffices.

In step S610, it is determined that confirming whether cancel is possible and cancel processing are performed for all the cancel candidate segments of the PUSH transmission instruction 802 by the PUSH transmission cancel instruction 810 (YES in step S610), and the process transitions to step S611.

In step S611, since the PUSH transmission instruction of the cancel target is only the PUSH transmission instruction 802 (YES in step S611), the process transitions to step S612.

In step S612, the communication unit 207 of the transmission apparatus 101 transmits the response 811 including a reply 812 to the PUSH transmission cancel instruction 810 in the push-policy header to the reception apparatus 102. This reply has the same contents as the PUSH transmission cancel instruction 810.

In step S707, the communication unit 308 of the reception apparatus 102 receives the response 811 including the reply 812 of the PUSH transmission cancel instruction.

For canceled segment A3, the transmission apparatus 101 has already transmitted the PUSH_PROMISE 807 to the reception apparatus 102. To cancel this, the transmission apparatus 101 transmits the RST_STREAM 813, and the reception apparatus 102 receives this. The RST_STREAM 813 may be transmitted by the reception apparatus 102 before step S706 or after step S707.

In HTTP/2, to cancel some of a plurality of push-policies or some of a plurality of segments scheduled to be PUSHed based on push-policy, it is necessary to temporarily cancel all PUSHs and then do necessary settings again. In HTTP/2, the ID of a stream is notified by PUSH_PROMISE for each segment of the PUSH target, and the PUSH of an arbitrary segment can be canceled by designating it. However, in a case in which PUSH_PROMISE is transmitted with a delay or in a case in which the client does not know the name of a segment to be canceled, a plurality of commands need to be exchanged, and therefore, transactions may increase to cause a delay.

To prevent this, in Operation Example 1, the transmission apparatus 101 notifies the reception apparatus 102 of the identifier 805 of URL form of the PUSH transmission instruction, and the reception apparatus 102 can thus specify the cancel target by the identifier 805 and instruct cancel. It is therefore possible to cancel PUSH transmission without needing extra transactions to specify the cancel target.

### Operation Example 2

An example in which a PUSH transmission instruction to be canceled is designated by an identifier of character string form, and all segments scheduled to be PUSHed by the PUSH transmission instruction are canceled on HTTP/2 will be described next with reference to FIGS. 9A and 9B.

Reference numerals 901 and 902 are the same as 801 and 802. In addition, the contents of the processes of step S601 in FIG. 6 and steps S701 and S702 in FIG. 7 are the same as those described with reference to FIGS. 8A and 8B, and a description thereof will be omitted.

In step S602, the instruction management unit 206 of the transmission apparatus 101 assigns an identifier 905 “push1” to the PUSH transmission instruction 902 received from the reception apparatus 102. FIGS. 9A and 9B show an example in which the form of a character string is employed as the identifier.

In step S603, the communication unit 207 of the transmission apparatus 101 transmits, to the reception apparatus 102, a response 903 that includes, in the push-policy header, a reply 904 of a PUSH transmission instruction having the same contents as the PUSH transmission instruction 902 as the reply to the PUSH transmission instruction 902. The response 903 also includes the binary data of segment A1. The push-policy header of the response 903 also includes the identifier 905 in correspondence with the reply 804 of the PUSH transmission instruction. Note that when a prefix “push-ID” is placed before the identifier 905, the point of the push-policy header at which the identifier 905 starts can be known. The prefix is not limited to “push-ID”. Instead of transmitting the identifier 905 together with the reply 904 of the PUSH transmission instruction, the transmission apparatus 101 may describe the identifier 905 in MPD and notify the reception apparatus 102 of it upon receiving an MPD acquisition request from the reception apparatus 102.

Reference numerals 906 to 908 are the same as 806 to 808. In addition, the contents of the processes of steps S604 and S605 in FIG. 6 and steps S703 to S705 in FIG. 7 are the same as the contents of PUSH transmission processing described with reference to FIGS. 8A and 8B, and a description thereof will be omitted.

In step S706, the communication unit 308 of the reception apparatus 102 transmits a request 909 including a PUSH transmission cancel instruction 911 in the accept-push-policy header to the transmission apparatus 101. The PUSH transmission cancel instruction 911 has contents to cancel all segments scheduled to be PUSH-transmitted by the PUSH transmission instruction 902. The PUSH transmission instruction 902 to be canceled can be designated by including the identifier 905 (“push1”) together in the accept-push-policy header of the request 909. As a URL 910 designated in path of the request 909, a URL described in MPD and shared in advance between the transmission apparatus 101 and the reception apparatus 102 is designated. Reference numerals 912 to 914 are the same as 811 to 813. In addition, the contents of the processes of steps S606 to S612 in FIG. 6 and step S707 in FIG. 7 are the same as the contents described with reference to FIGS. 8A and 8B, and a description thereof will be omitted.

In Operation Example 2, the transmission apparatus 101 notifies the reception apparatus 102 of the identifier 905 of character string form of the PUSH transmission instruction, and the reception apparatus 102 can thus specify the cancel target by the identifier 905 and instruct cancel. It is therefore possible to cancel PUSH transmission without needing extra transactions to specify the cancel target.

### Operation Example 3

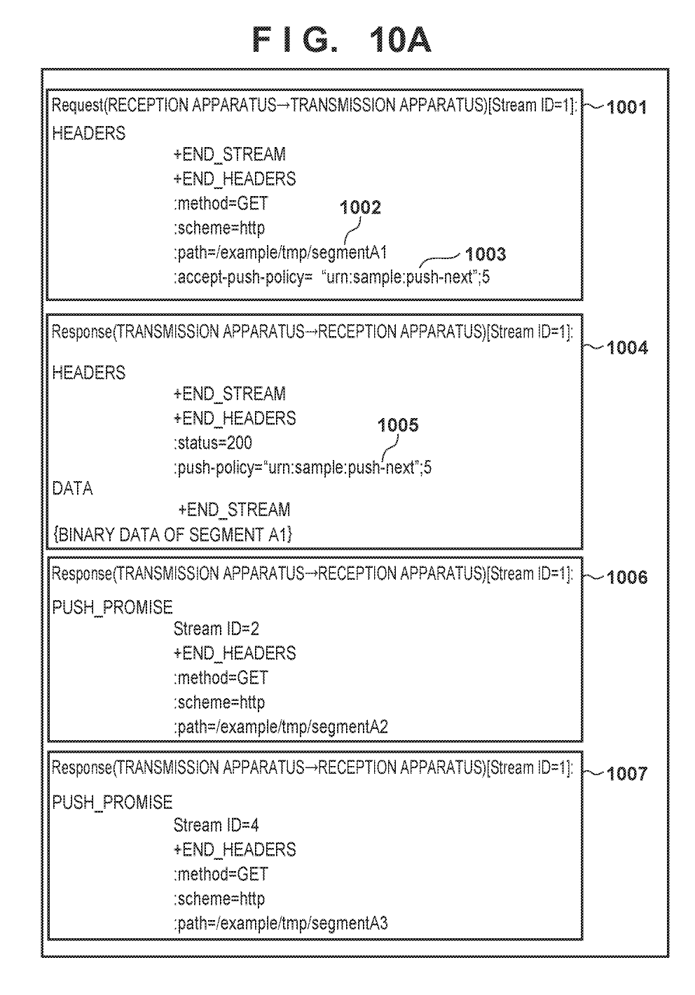

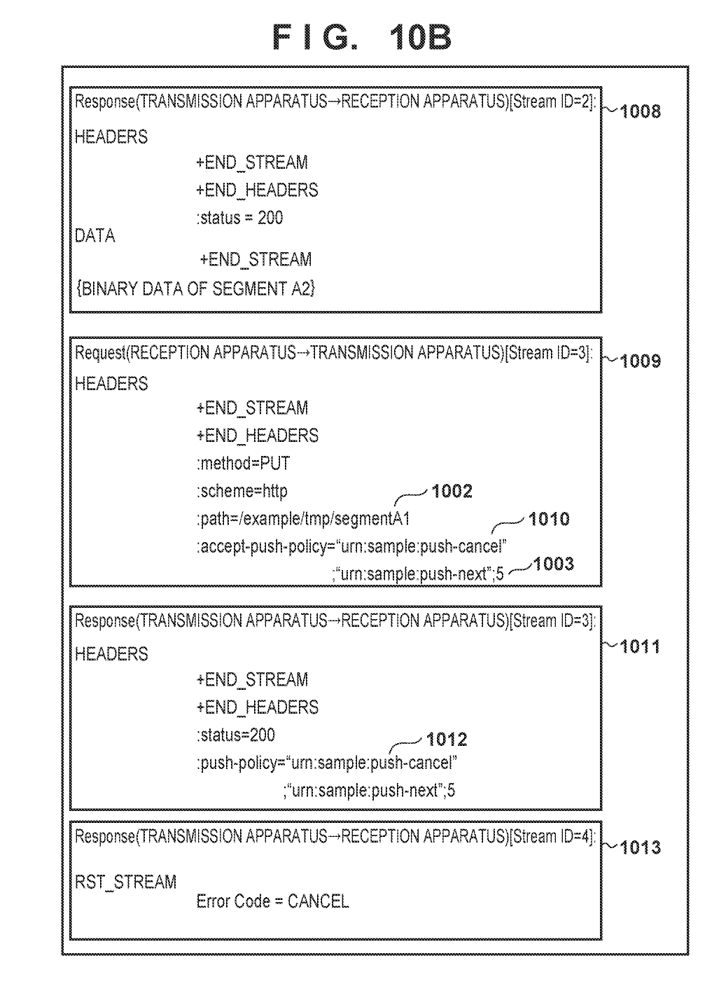

An example in which a PUSH transmission instruction to be canceled is designated by the combination of the contents of a PUSH transmission instruction and a resource acquired together when transmitting the PUSH transmission instruction on HTTP/2 will be described next with reference to FIGS. 10A and 10B. FIGS. 10A and 10B show an example in which all segments scheduled to be PUSHed by a PUSH transmission instruction are canceled.

Reference numerals 1001 and 1003 in FIGS. 10A and 10B are the same as 801 and 802 in FIGS. 8A and 8B. In addition, the contents of the processes of step S601 in FIG. 6 and steps S701 and S702 in FIG. 7 are the same as those described with reference to FIGS. 8A and 8B, and a description thereof will be omitted.

In the example shown in FIGS. 10A and 10B, a PUSH transmission cancel instruction is done by the combination of the contents of a PUSH transmission instruction and a resource acquired together when transmitting the PUSH transmission instruction. For this reason, step S602 in which the transmission apparatus 101 assigns an identifier to the PUSH transmission instruction is skipped. In FIGS. 10A and 10B, the resource is “segment A1” (resource 1002) that is the GET target in the request 1001.

In step S603, the communication unit 207 of the transmission apparatus 101 returns a response 1004 including a reply to the PUSH transmission instruction 1003 to the reception apparatus 102. In the example shown in FIGS. 10A and 10B, the response 1004 includes, in the push-policy header, a reply 1005 of a PUSH transmission instruction having the same contents as the PUSH transmission instruction 1003. In addition, the response 1004 includes the binary data of segment A1. Unlike the operation examples described with reference to FIGS. 8A and 8B and FIGS. 9A and 9B, the response 1004 does not include the identifier of the PUSH transmission instruction.

Reference numerals 1006 to 1008 are the same as 806 to 808 in FIGS. 8A and 8B. In addition, the contents of the processes of steps S604 and S605 in FIG. 6 and steps S703 to S705 in FIG. 7 are the same as the contents of PUSH transmission processing described with reference to FIGS. 8A and 8B, and a description thereof will be omitted.

In step S706, the communication unit 308 of the reception apparatus 102 transmits a request 1009 including a PUSH transmission cancel instruction 1010 in the accept-push-policy header to the transmission apparatus 101. The PUSH transmission cancel instruction 1010 has contents to cancel all segments scheduled to be PUSH-transmitted by the PUSH transmission instruction 1003. Segment A1 (resource 1002) that is the GET target in the request 1001 is included in the path header, and the contents of the PUSH transmission instruction 1003 are included in the accept-push-policy header. The PUSH transmission instruction 1003 to be canceled is thus designated. When the push transmission instruction contents and the resource are combined, the cancel target can be designated even if the same PUSH transmission instruction contents are used for a plurality of resources.

Reference numerals 1011 to 1013 are the same as 811 to 813 in FIGS. 8A and 8B. In addition, the contents of the processes of steps S606 to S612 in FIG. 6 and step S707 in FIG. 7 are the same as the contents of processing described with reference to FIGS. 8A and 8B, and a description thereof will be omitted.

In Operation Example 3, the reception apparatus 102 designates the PUSH transmission instruction to be canceled by the combination of the contents of a PUSH transmission instruction and a resource acquired together when transmitting the PUSH transmission instruction. It is possible to specify the cancel target by the PUSH transmission instruction 1003 and the resource 1002 and instruct cancel. Hence, the reception apparatus 102 can cancel PUSH transmission by directly specifying the cancel target without needing extra transactions.

### Operation Example 4

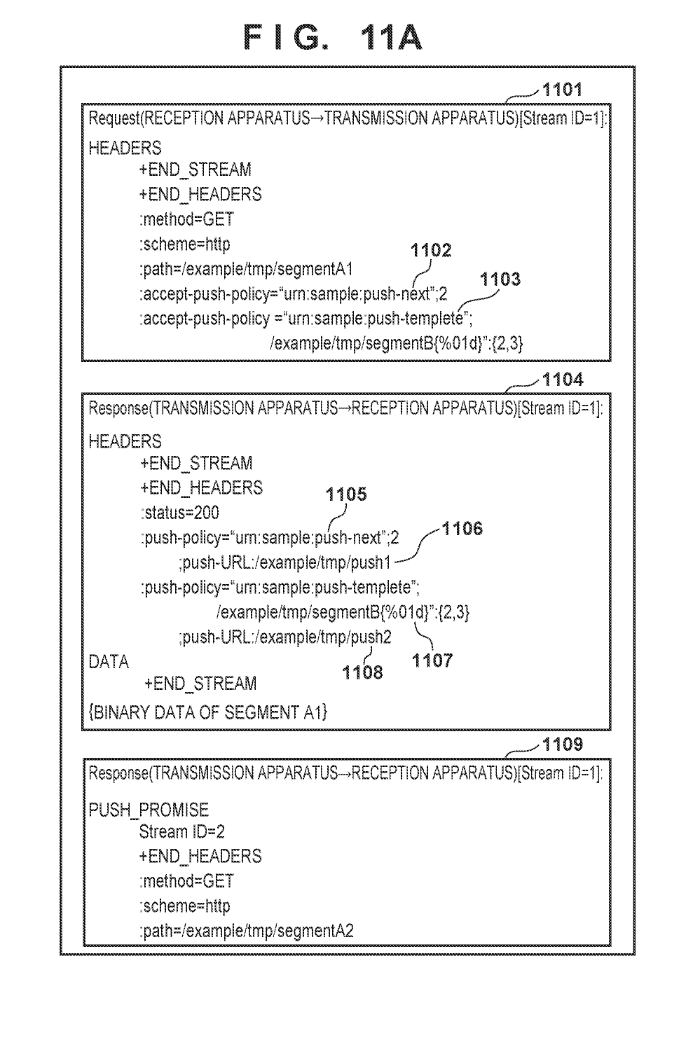

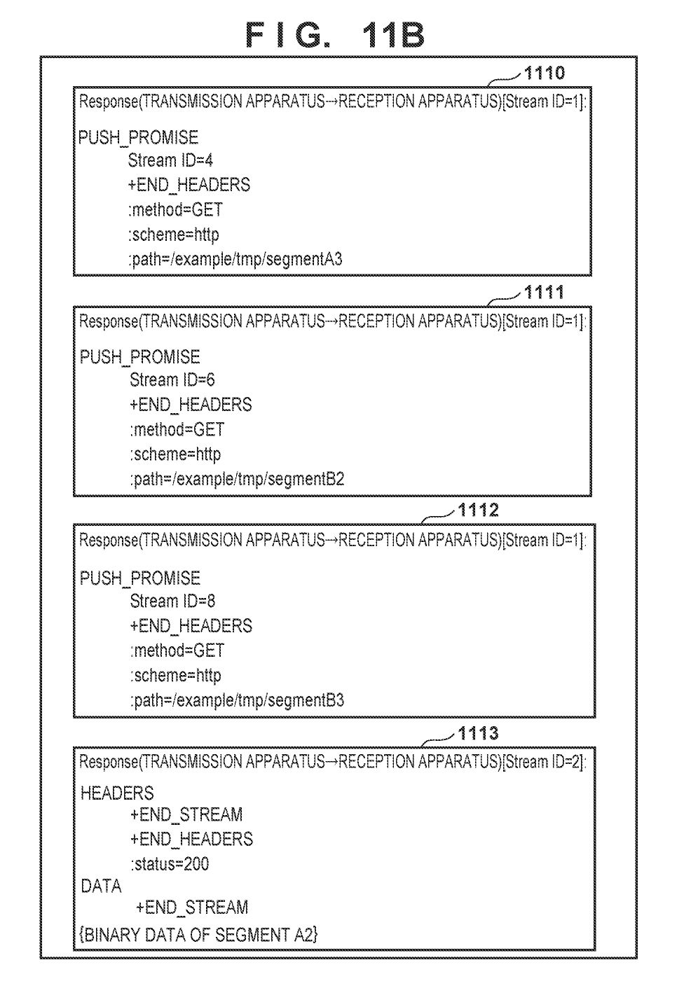

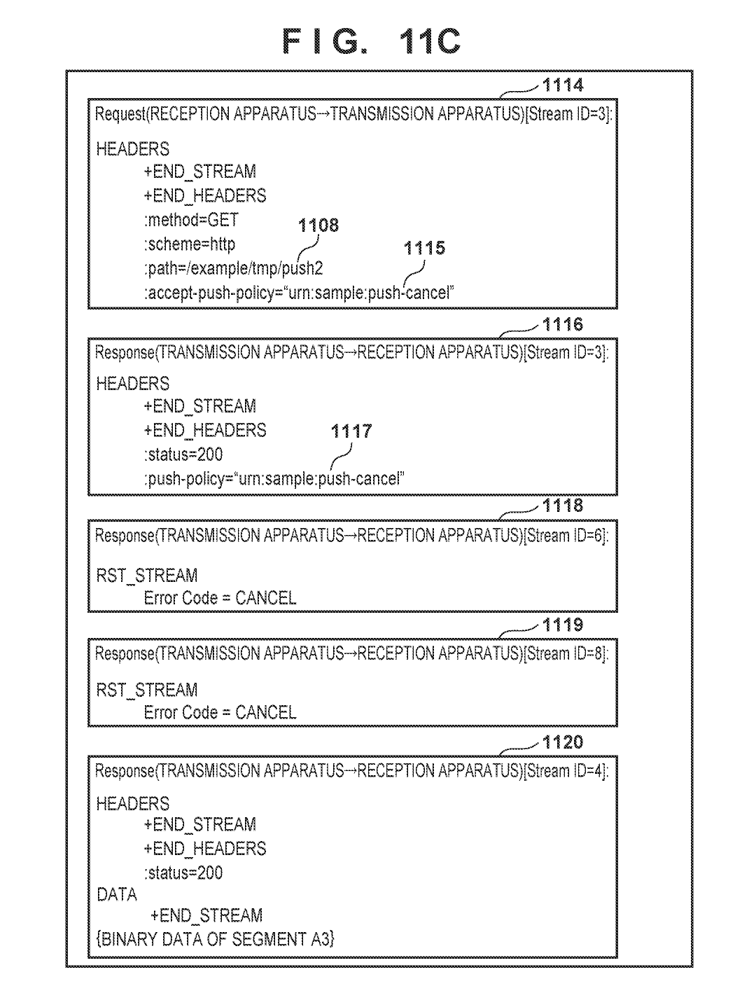

An example in which after a plurality of PUSH transmission instructions are requested, one PUSH transmission instruction to be canceled is designated by an identifier of URL form, and all segments scheduled to be PUSHed by the PUSH transmission instruction are canceled on HTTP/2 will be described next with reference to FIGS. 11A, 11B, and 11C. In this example, an identifier is assigned by the transmission apparatus 101, and step S701 in which the reception apparatus 102 assigns an identifier to a PUSH transmission instruction is skipped.

In step S702, the communication unit 308 of the reception apparatus 102 transmits a request 1101 including PUSH transmission instructions 1102 and 1103 in the accept-push-policy headers to the transmission apparatus 101. The request 1101 includes two accept-push-policy headers, and includes the PUSH transmission instructions 1102 and 1103 by the two headers. The PUSH transmission instructions 1102 and 1103 may be included not in separate accept-push-policy headers but in one accept-push-policy header. In the PUSH transmission instruction 1102, a number “2” next to “urn:sample:push-next” designates the number of segments to be acquired next to “/example/tmp/segmentA1”, like 802 in FIGS. 8A and 8B. Hence, the reception apparatus 102 requests PUSH transmission of segment A2 and segment A3 by the PUSH transmission instruction 1102. Additionally, in the PUSH transmission instruction 1103, two numbers in parentheses next to “/example/tmp/segment(%01d)” specify segments of request targets by the range of values that “(%01d)” can take. In the example of 1103, since “{2,3}” is designated as the range, the PUSH transmission instruction 1103 requests PUSH transmission of segment B2 and segment B3.

In step S601, the communication unit 207 of the transmission apparatus 101 receives the request 1101 including the PUSH transmission instructions 1102 and 1103.

In step S602, the instruction management unit 206 of the transmission apparatus 101 assigns an identifier 1106 “/example/tmp/push1” to the received PUSH transmission instruction 1102. In addition, the instruction management unit 206 assigns an identifier 1108 “/example/tmp/push2” to the PUSH transmission instruction 1103. In this example, the identifiers employ the form of a URL.

In step S603, the communication unit 207 of the transmission apparatus 101 transmits a response 1104 including replies to the PUSH transmission instructions 1102 and 1103 in the push-policy headers to the reception apparatus 102. The response 1104 also includes the binary data of segment A1. In the example shown in FIGS. 11A, 11B, and 11C, replies 1105 and 1107 of the PUSH transmission instructions having the same contents as the PUSH transmission instructions 1102 and 1103 are included as the replies to the PUSH transmission instructions 1102 and 1103. The response 1104 includes two push-policy headers, and includes the replies 1105 and 1107 of the PUSH transmission instructions by the two headers. Note that the replies 1105 and 1107 of the PUSH transmission instructions may be included not in separate push-policy headers but in one push-policy header. In the example shown in FIGS. 11A, 11B, and 11C, the identifier 1106 (“push1”) is included in correspondence with the reply 1105, and the identifier 1108 (“push2”) is included in correspondence with the reply 1107. When a prefix “push-URL” is placed before each of the identifiers 1106 and 1108, the point of the push-policy header at which the identifier 1106 or 1108 starts can be discriminated. The prefix is not limited to “push-URL”.

After transmission of the response 1104, for segments scheduled to be PUSH-transmitted on HTTP/2, the transmission apparatus 101 transmits PUSH_PROMISEs 1109 to 1112 that reserve streams to be used to transmit the segments to the reception apparatus 102. The reception apparatus 102 receives the PUSH_PROMISEs 1109 to 1112 from the transmission apparatus 101. The PUSH_PROMISEs 1109, 1110, 1111, and 1112 may be transmitted/received before the response 1104.

In step S604, the instruction management unit 206 of the transmission apparatus 101 holds the received PUSH transmission instruction 1102 and the identifier 1106 and the PUSH transmission instruction 1103 and the identifier 1108 by linking them with each other.

In step S703, the communication unit 308 of the reception apparatus 102 receives the response 1104 including the reply 1105 to the PUSH transmission instruction 1102 and the reply 1107 to the PUSH transmission instruction 1103.

In step S704, the instruction management unit 306 of the reception apparatus 102 holds the PUSH transmission instructions 1102 and 1103 whose replies are returned and accepted by linking them with the identifiers 1106 and 1108.

In step S605, the transmission apparatus 101 starts PUSH transmission, and the communication unit 207 of the transmission apparatus 101 transmits a response 1113 including the binary data of segment A2 to the reception apparatus 102 as the PUSH transmission of segment A2.

In step S705, the communication unit 308 of the reception apparatus 102 receives the response 1113.

In step S706, the communication unit 308 of the reception apparatus 102 transmits a request 1114 including a PUSH transmission cancel instruction 1115 in the accept-push-policy header. In this example, the PUSH transmission cancel instruction 1115 has contents to cancel all segments scheduled to be PUSH-transmitted by the PUSH transmission instruction 1103 identified by the identifier 1108. The identifier 1108 corresponding to the PUSH transmission instruction 1103 to be canceled is designated in the path header of the request 1114.

In step S606, the communication unit 207 of the transmission apparatus 101 receives the request 1114 including the PUSH transmission cancel instruction 1115 from the reception apparatus 102.

In step S607, the instruction management unit 206 of the transmission apparatus 101 specifies, as a cancel candidate segment, one of the segments scheduled to be PUSHed by the PUSH transmission instruction 1103 that is the cancel target determined based on the identifier 1108. In this example, since the segments scheduled to be PUSHed by the PUSH transmission instruction 1103 are segment B2 and segment B3, segment B2 that is one of the segments is specified as the cancel candidate segment.

In step S608, it is determined that segment B2 as the cancel candidate segment is not the PUSH transmission target by the PUSH transmission instruction 1102 employed by the transmission apparatus 101 in addition to the PUSH transmission instruction 1103 (NO in step S608), and the process transitions to step S609.

In step S609, the instruction management unit 206 of the transmission apparatus 101 outputs, to the segment decision unit 205, an instruction to cancel PUSH transmission of segment B2, and the segment decision unit 205 cancels the PUSH transmission of segment B2. As detailed cancel processing, since the transmission is already reserved by the PUSH_PROMISE 1111, transmission of an RST_STREAM 1118 used to cancel the transmission reservation and processing of stopping PUSH transmission in the transmission apparatus 101 are performed.

In step S610, it is determined that confirming whether cancel is possible and cancel processing are not performed for all the cancel candidate segments of the PUSH transmission instruction 1103 by the PUSH transmission cancel instruction 1115 (NO in step S610). This is because the processing is not performed for segment B3 in the segments scheduled to be PUSHed. Hence, the process transitions to step S607.

In step S607, the instruction management unit 206 of the transmission apparatus 101 specifies, as a cancel candidate segment, segment B3 that is one of segments scheduled to be PUSHed by the PUSH transmission instruction 1103 that is the cancel target determined based on the identifier 1108.

In step S608, it is determined that segment B3 that is the cancel candidate segment is not the PUSH transmission target of the PUSH transmission instruction 1102 employed by the transmission apparatus 101 in addition to the PUSH transmission instruction 1103 (NO in step S608), and the process transitions to step S609.

In step S609, the instruction management unit 206 of the transmission apparatus 101 outputs, to the segment decision unit 205, an instruction to cancel PUSH transmission of segment B3, and the segment decision unit 205 cancels the PUSH transmission of segment B3. As detailed cancel processing, since the transmission is already reserved by the PUSH_PROMISE 1112, transmission of an RST_STREAM 1119 used to cancel the transmission reservation and processing of stopping PUSH transmission in the transmission apparatus 101 are performed.

In step S610, it is determined that confirming whether cancel is possible and cancel processing are performed for all the cancel candidate segments of the PUSH transmission instruction 1103 by the PUSH transmission cancel instruction 1115 (YES in step S610), and the process transitions to step S611.

In step S611, since the PUSH transmission instruction of the cancel target is only the PUSH transmission instruction 1103 (YES in step S611), the process transitions to step S612.

In step S612, the communication unit 207 of the transmission apparatus 101 transmits a response 1116 including a reply 1117 to the PUSH transmission cancel instruction 1115 in the push-policy header to the reception apparatus 102. The reply 1117 has the same contents as the PUSH transmission cancel instruction 1115.

In step S707, the communication unit 308 of the reception apparatus 102 receives the response 1116 including the reply 1117 of the PUSH transmission cancel instruction.

For canceled segment B2 and segment B3, the transmission apparatus 101 has already transmitted the PUSH_PROMISEs 1111 and 1112 to the reception apparatus 102. Hence, these need to be canceled. To do this, the transmission apparatus 101 transmits the RST_STREAMs 1118 and 1119 to the reception apparatus 102, and the reception apparatus 102 receives them. The RST_STREAMs 1118 and 1119 may be transmitted by the reception apparatus 102 before step S706 or after step S707.

In Operation Example 4, an example in which the two PUSH transmission instructions 1102 and 1103 are transmitted, and cancel of all segments is instructed for one PUSH transmission instruction has been described. In Operation Example 4, the identifiers 1106 and 1108 are assigned to the PUSH transmission instructions to enable designation of a PUSH transmission instruction. It is therefore possible to cancel PUSH transmission without needing extra transactions to specify the cancel target.

### Operation Example 5

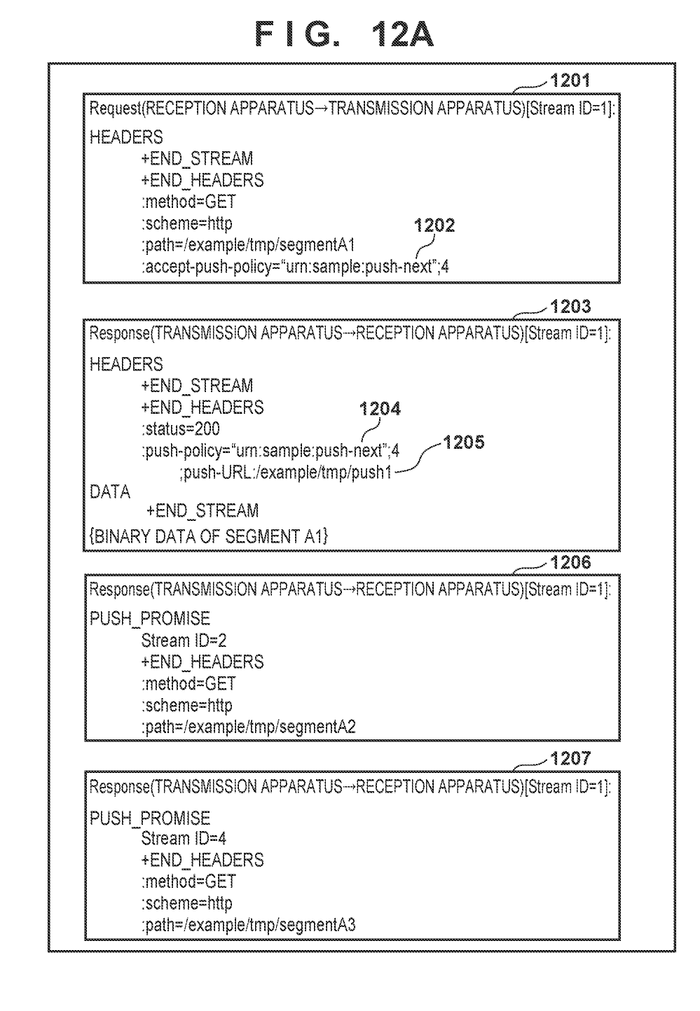

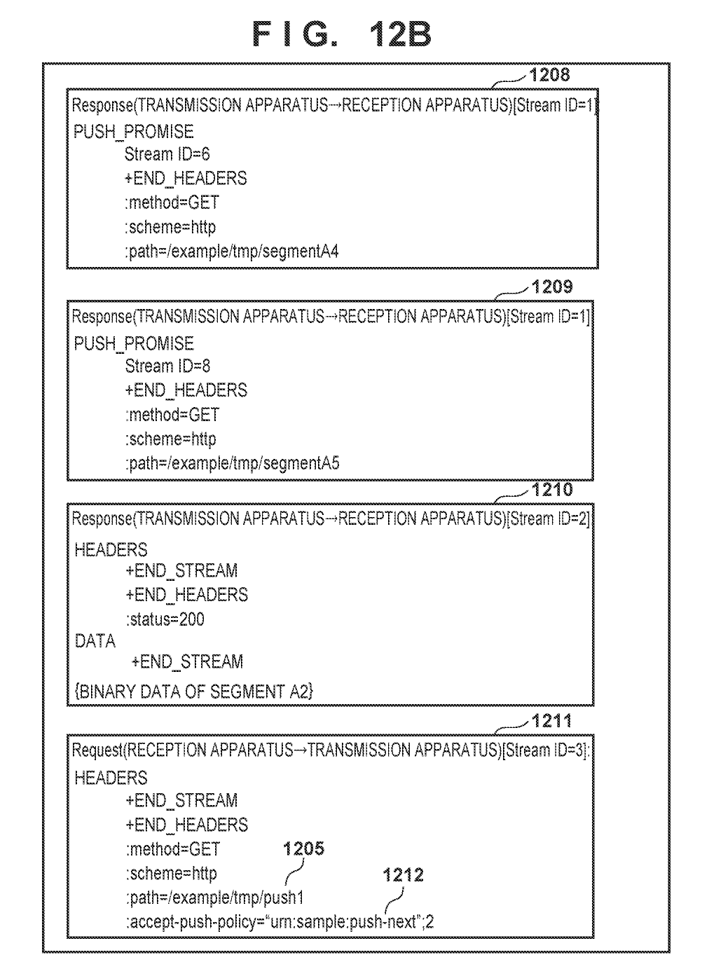

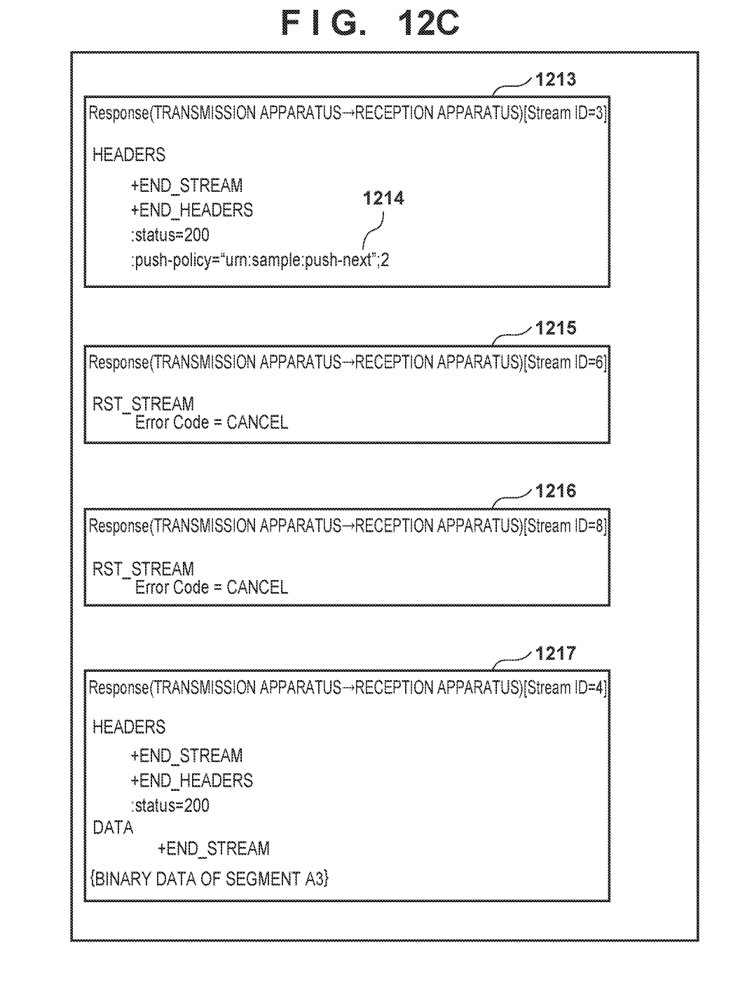

An example in which a PUSH transmission instruction to be canceled is designated by an identifier of URL form, and some of segments scheduled to be PUSHed by the PUSH transmission instruction are canceled on HTTP/2 will be described next with reference to FIGS. 12A, 12B, and 12C.

Reference numerals 1201 to 1207 and 1210 are the same as 801 to 808. In addition, the contents of the processes of steps S601 to S605 in FIG. 6 and steps S701 to S705 in FIG. 7 are the same as the contents of processing described with reference to FIGS. 8A and 8B, and a description thereof will be omitted. In the example shown in FIGS. 12A, 12B, and 12C, however, the PUSH transmission instruction 1202 requests PUSH transmission of following four segments continuing from segment A1 in terms of reproduction time. Additionally, PUSH_PROMISEs 1208 and 1209 that reserve transmission of segment A4 and segment A5 are transmitted together with the PUSH_PROMISEs 1206 and 1207.

In step S706, the reception apparatus 102 transmits a request 1211 including a PUSH transmission instruction 1212 in the accept-push-policy header to the transmission apparatus 101. The PUSH transmission instruction 1212 is an instruction to cancel two segments from the end in the segments scheduled to be transmitted for the PUSH transmission instruction 1202 that instructs PUSH transmission of the following four segments continuing from segment A1 in terms of reproduction time. This will be described in more detail. The PUSH transmission instruction 1212 requests PUSH transmission of two continuous segment A2 and segment A3, which follow segment A1 and are identified by an identifier “push1” (1205). In the request 1201, PUSH transmission of four continuous segments following segment A1 is requested (PUSH transmission instruction 1202). Hence, the PUSH transmission instruction 1212 corresponds to a request to cancel the transmission request of segment A4 and segment A5. In this way, in the example shown in FIGS. 12A, 12B, and 12C, if PUSH transmission requests of different contents are transmitted/received for PUSH transmission requests identified by the same identifier, the operation is performed in accordance with the request transmitted/received finally. The PUSH transmission instruction 1202 to be canceled is designated by designating the identifier 1205 in the path header of the request 1211.

In step S606, the communication unit 207 of the transmission apparatus 101 receives the request 1211 including the PUSH transmission cancel instruction 1212 from the reception apparatus 102.

In step S607, the instruction management unit 206 of the transmission apparatus 101 specifies, as a cancel candidate segment, segment A4 that is one of the segments scheduled to be PUSHed by the PUSH transmission instruction 1202 that is the cancel target determined based on the identifier 1205. Since any PUSH transmission instruction other than the PUSH transmission instruction 1202 is not instructed in the transmission apparatus 101, step S608 is skipped, and the process transitions to step S609.

In step S609, the instruction management unit 206 of the transmission apparatus 101 outputs, to the segment decision unit 205, an instruction to cancel PUSH transmission of segment A4, and the segment decision unit 205 cancels the PUSH transmission of segment A4. As detailed cancel processing, since the transmission is already reserved by the PUSH_PROMISE 1208, transmission of the RST_STREAM 1215 used to cancel the transmission reservation and processing of stopping PUSH transmission in the transmission apparatus 101 are performed.

In step S610, it is determined that confirming whether cancel is possible and cancel processing are not performed for all the cancel candidate segments of the PUSH transmission instruction 1202 by the PUSH transmission cancel instruction 1212 (NO in step S610). This is because the processing is not performed for segment A5. Hence, the process transitions to step S607.

In step S607, the instruction management unit 206 of the transmission apparatus 101 specifies, as a cancel candidate segment, segment A5 that is one of segments scheduled to be PUSHed by the PUSH transmission instruction 1202 that is the cancel target determined based on the identifier 1205. Since any PUSH transmission instruction other than the PUSH transmission instruction 1202 is not instructed in the transmission apparatus 101, step S608 is skipped, and the process transitions to step S609.

In step S609, the instruction management unit 206 of the transmission apparatus 101 outputs, to the segment decision unit 205, an instruction to cancel PUSH transmission of segment A5, and the segment decision unit 205 cancels the PUSH transmission of segment A5. As detailed cancel processing, since the transmission is already reserved by the PUSH_PROMISE 1209, transmission of an RST_STREAM 1216 used to cancel the transmission reservation and processing of stopping PUSH transmission in the transmission apparatus 101 are performed.

In step S610, it is determined that confirming whether cancel is possible and cancel processing are performed for all the cancel candidate segments of the PUSH transmission instruction 1202 by the PUSH transmission cancel instruction 1212 (YES in step S610), and the process transitions to step S611.

In step S611, since the PUSH transmission instruction of the cancel target is only the PUSH transmission instruction 1202 (YES in step S611), the process transitions to step S612.

In step S612, the communication unit 207 of the transmission apparatus 101 transmits a response 1213 including a reply 1214 to the PUSH transmission cancel instruction 1212 in the push-policy header to the reception apparatus 102. The reply 1214 has the same contents as the PUSH transmission cancel instruction 1212.

In step S707, the communication unit 308 of the reception apparatus 102 receives the response 1213 including the reply 1214 of the PUSH transmission cancel instruction.

For canceled segment A4 and segment A5, the transmission apparatus 101 has transmitted the PUSH_PROMISEs 1208 and 1209 to the reception apparatus 102. Hence, to cancel these, the transmission apparatus 101 transmits the RST_STREAMs 1215 and 1216, and the reception apparatus 102 receives these. The RST_STREAMs 1215 and 1216 may be transmitted by the reception apparatus 102 before step S706 or after step S707.

In Operation Example 5, an example has been described in which the identifier 1205 is added to the PUSH transmission instruction, and the reception apparatus 102 can thus designate the identifier 1205 and cancel transmission of some of the segments of transmission targets without needing extra transactions.

### Operation Example 6

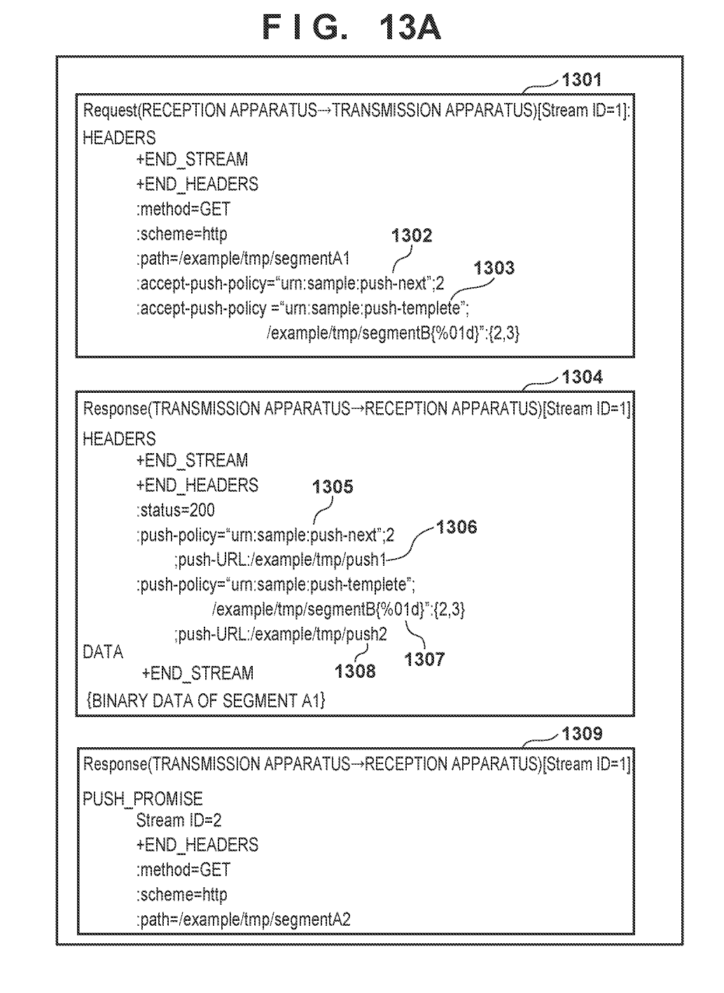

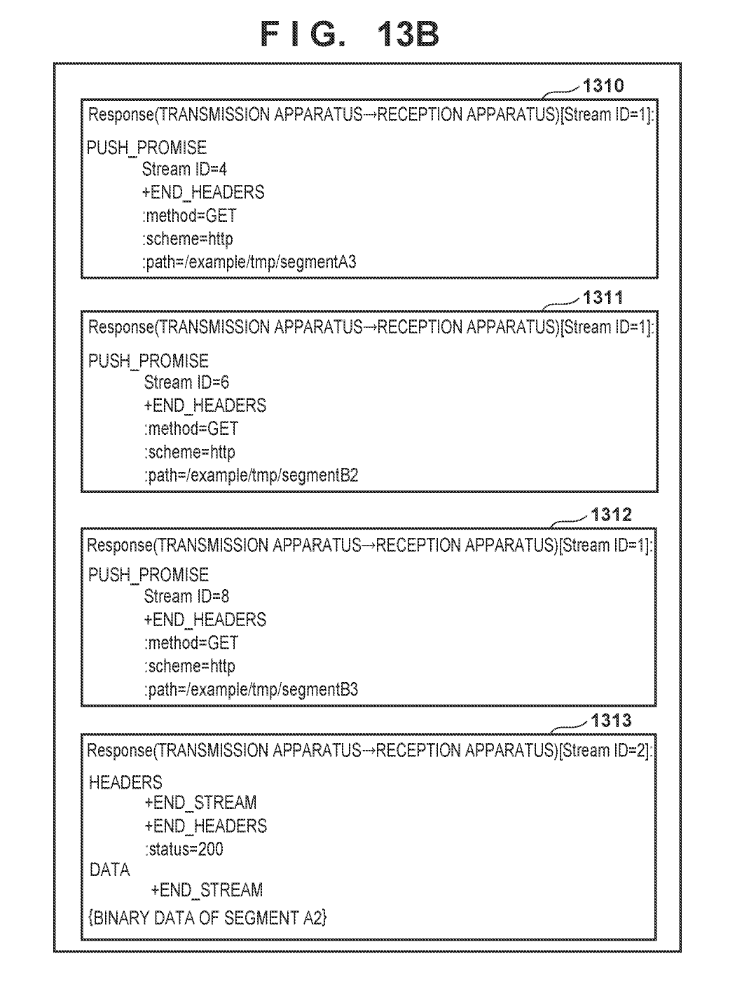

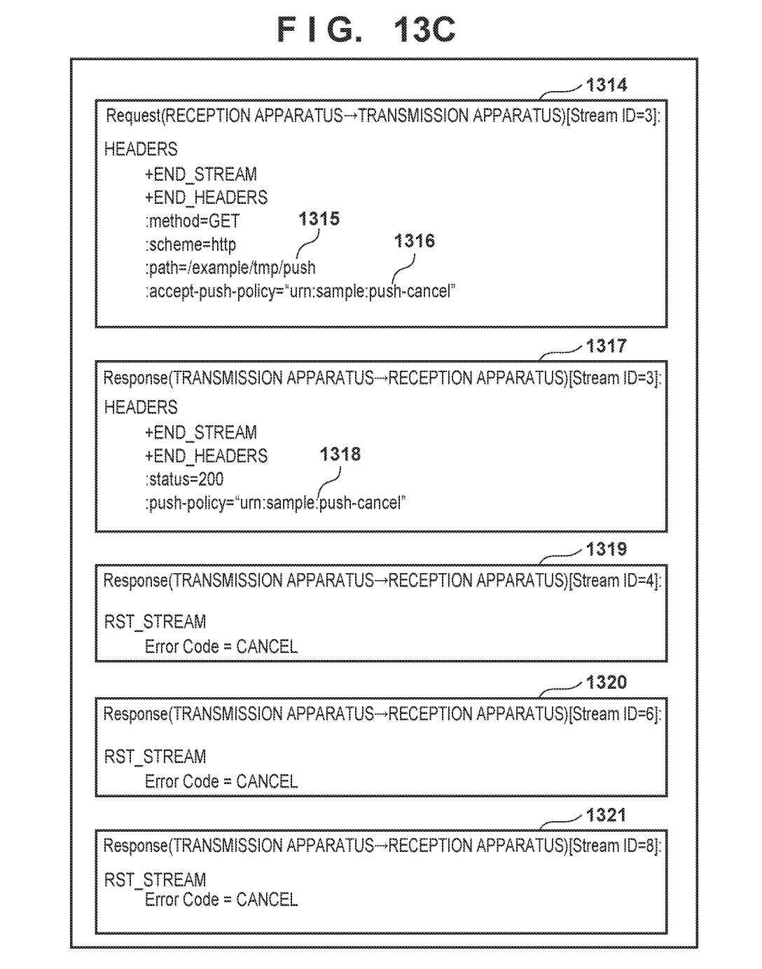

An example in which after a plurality of PUSH transmission instructions are requested and employed, all the PUSH transmission instructions are designated as cancel targets by an identifier of URL form on HTTP/2 will be described next with reference to FIGS. 13A, 13B, and 13C. FIGS. 13A, 13B, and 13C show an example in which all segments scheduled to be PUSH-transmitted by the PUSH transmission instructions are canceled. Reference numerals 1301 to 1313 in FIGS. 13A, 13B and 13C are the same as 1101 to 1113 in FIGS. 11A, 11B, and 11C. In addition, the contents of the processes of steps S601 to S605 in FIG. 6 and steps S701 to S705 in FIG. 7 are the same as the contents of processing described with reference to FIGS. 11A, 11B, and 11C and FIGS. 8A and 8B, and a description thereof will be omitted.

In step S706, the communication unit 308 of the reception apparatus 102 transmits a request 1314 including a PUSH transmission cancel instruction 1316 in the accept-push-policy header to the transmission apparatus 101. The PUSH transmission cancel instruction 1316 is a cancel instruction having contents to cancel all segments scheduled to be PUSH-transmitted by both the PUSH transmission instructions 1302 and 1303. An identifier 1315 (“push”) indicating all PUSH transmission instructions being currently employed by the transmission apparatus 101 is designated in the path header of the request 1314. The transmission apparatus 101, for example, describes the identifier 1315 in MPD in advance, thereby notifying the reception apparatus 102 of it in advance. In addition to this method, the identifier that designates all the PUSH transmission instructions may be known from the form of the identifier assigned to each PUSH transmission instruction. For example, assume that the identifier assigned to each PUSH transmission instruction has a form of “character string+numerical value”. Then, an identifier formed by a character string portion remaining after the numerical value of the identifier assigned to each PUSH transmission instruction is removed may represent the identifier used to designate all the PUSH transmission instructions. The transmission apparatus 101 and the reception apparatus 102 share this rule in advance. The identifiers 1306 and 1308 assigned to the PUSH transmission instructions 1302 and 1303 in FIGS. 13A, 13B, and 13C are “/example/tmp/push1” and “/example/tmp/push2”, respectively. The reception apparatus 102 can know that the identifier used to designate all the PUSH transmission instructions is “/example/tmp/push” that does not include the numerical value.

In step S606, the communication unit 207 of the transmission apparatus 101 receives the request 1314 including the PUSH transmission cancel instruction 1316.

In step S607, the instruction management unit 206 of the transmission apparatus 101 specifies, as a cancel candidate segment, an untransmitted segment in the segments scheduled to be PUSHed by the PUSH transmission instruction 1302 that is one of the cancel targets determined based on the identifier 1315. In this example, segment A3 that is one of the untransmitted segments is specified as the cancel candidate segment.

In step S608, it is determined that segment A3 as the cancel candidate segment is not the PUSH transmission target by the PUSH transmission instruction 1303 employed by the transmission apparatus 101 in addition to the PUSH transmission instruction 1302 (NO in step S608), and the process transitions to step S609.

In step S609, the instruction management unit 206 of the transmission apparatus 101 outputs, to the segment decision unit 205, an instruction to cancel PUSH transmission of segment A3, and the segment decision unit 205 cancels the PUSH transmission of segment A3. As detailed cancel processing, since the transmission is already reserved by the PUSH_PROMISE 1310, transmission of an RST_STREAM 1319 used to cancel the transmission reservation and processing of stopping PUSH transmission in the transmission apparatus 101 are performed.

In step S610, it is determined that confirming whether cancel is possible and cancel processing are performed for all the cancel candidate segments of the PUSH transmission instruction 1302 by the PUSH transmission cancel instruction 1316 (YES in step S610), and the process transitions to step S611.

In step S611, since the PUSH transmission instruction 1303 exists as the cancel target in addition to the PUSH transmission instruction 1302 (NO in step S611), the process transitions to step S607.

In step S607, the instruction management unit 206 of the transmission apparatus 101 specifies, as a cancel candidate segment, segment B2 that is one of the segments scheduled to be PUSHed by the PUSH transmission instruction 1303 that is one of the cancel targets determined based on the identifier 1315.

In step S608, it is determined that segment B2 as the cancel candidate segment is not the PUSH transmission target by the PUSH transmission instruction 1302 employed by the transmission apparatus 101 in addition to the PUSH transmission instruction 1303 (NO in step S608), and the process transitions to step S609.

In step S609, the instruction management unit 206 of the transmission apparatus 101 outputs, to the segment decision unit 205, an instruction to cancel PUSH transmission of segment B2, and the segment decision unit 205 cancels the PUSH transmission of segment B2. As detailed cancel processing, since the transmission is already reserved by the PUSH_PROMISE 1311, transmission of an RST_STREAM 1320 used to cancel the transmission reservation and processing of stopping PUSH transmission in the transmission apparatus 101 are performed.

In step S610, it is determined that confirming whether cancel is possible and cancel processing are not performed for all the cancel candidate segments of the PUSH transmission instruction 1303 by the PUSH transmission cancel instruction 1316 (NO in step S610), and the process transitions to step S607.

In step S607, the instruction management unit 206 of the transmission apparatus 101 specifies, as a cancel candidate segment, segment B3 that is one of the segments scheduled to be PUSHed by the PUSH transmission instruction 1303 that is one of the cancel targets determined based on the identifier 1315.

In step S608, it is determined that segment B3 as the cancel candidate segment is not the PUSH transmission target by the PUSH transmission instruction 1302 employed by the transmission apparatus 101 in addition to the PUSH transmission instruction 1303 (NO in step S608), and the process transitions to step S609.

In step S609, the instruction management unit 206 of the transmission apparatus 101 outputs, to the segment decision unit 205, an instruction to cancel PUSH transmission of segment B3, and the segment decision unit 205 cancels the PUSH transmission of segment B3. As detailed cancel processing, since the transmission is already reserved by the PUSH_PROMISE 1312, transmission of an RST_STREAM 1321 used to cancel the transmission reservation and processing of stopping PUSH transmission in the transmission apparatus 101 are performed.

In step S610, it is determined that confirming whether cancel is possible and cancel processing are performed for all the cancel candidate segments of the PUSH transmission instruction 1303 by the PUSH transmission cancel instruction 1316 (YES in step S610), and the process transitions to step S611.

In step S611, it is determined that all the PUSH transmission instructions at which the PUSH transmission cancel instruction 1316 aims are canceled (YES in step S611), and the process transitions to step S612.

In step S612, the communication unit 207 of the transmission apparatus 101 transmits a response 1317 including a reply 1318 to the PUSH transmission cancel instruction 1316 in the push-policy header to the reception apparatus 102. The reply 1318 has the same contents as the PUSH transmission cancel instruction 1316.

In step S707, the communication unit 308 of the reception apparatus 102 receives the response 1317 including the reply 1318 of the PUSH transmission cancel instruction from the transmission apparatus 101.

For canceled segment A3, segment B2, and segment B3, the transmission apparatus 101 has transmitted the PUSH_PROMISEs 1310 to 1312 to the reception apparatus 102. For this reason, to cancel these, the transmission apparatus 101 transmits the RST_STREAMs 1319 to 1321, and the reception apparatus 102 receives them. The RST_STREAMs 1319 to 1321 may be transmitted by the reception apparatus 102 before step S706 or after step S707.

In Operation Example 6, an example has been described in which in a case in which a plurality of PUSH transmission instructions are requested, to cancel PUSH transmission of each PUSH transmission instruction, a common identifier is used for the PUSH transmission instructions, thereby obviating the need of extra transactions.

### Operation Example 7

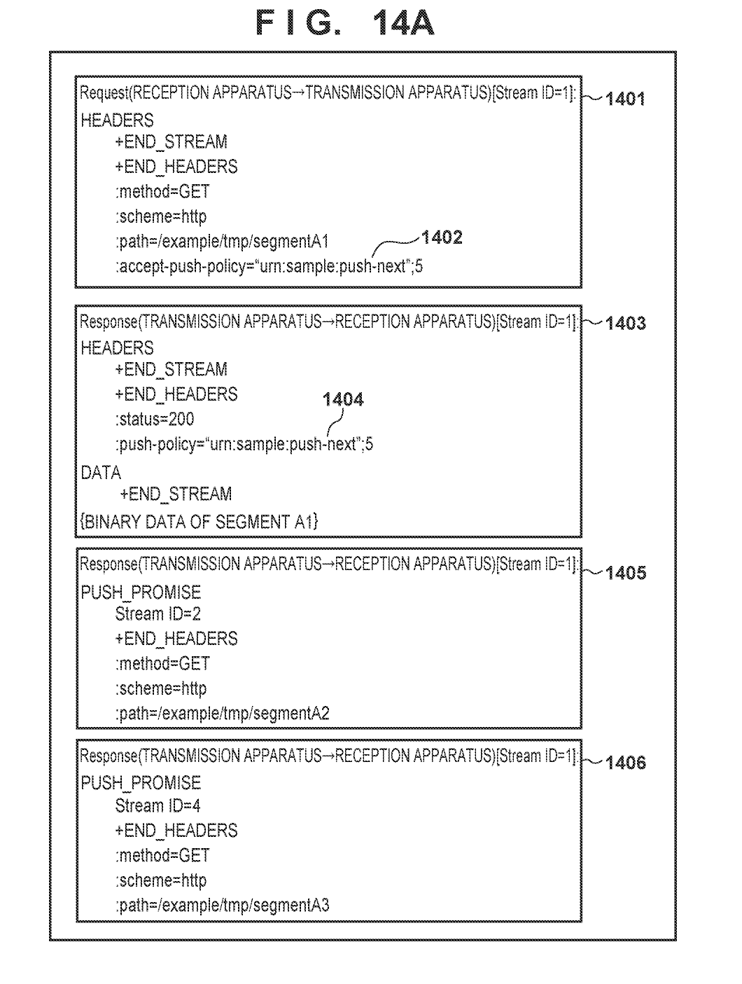

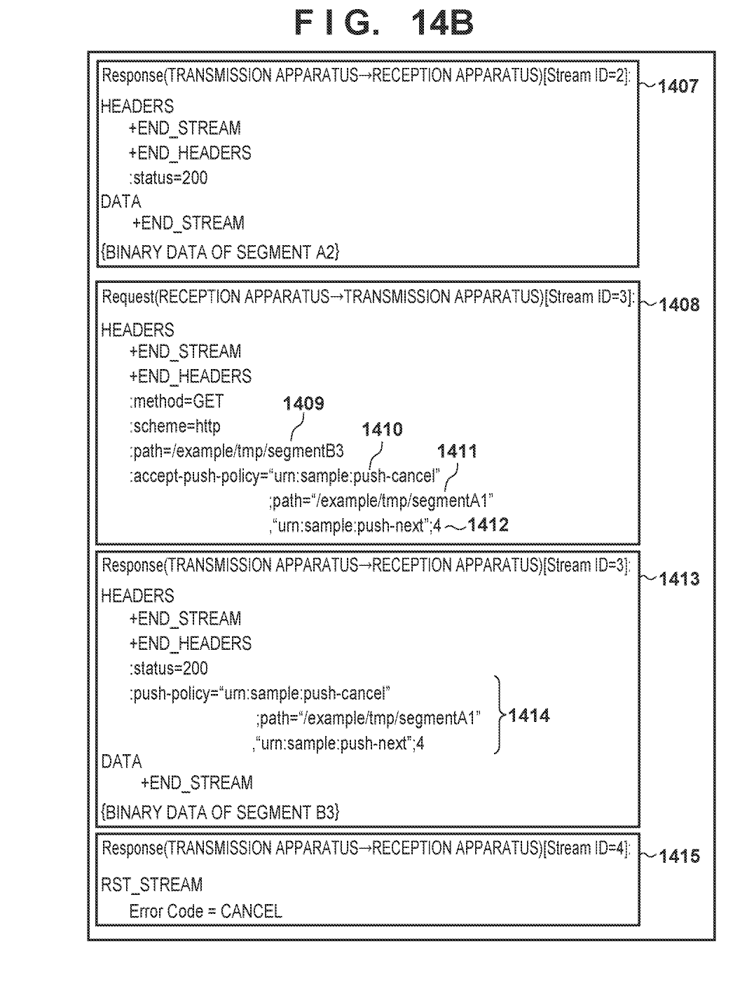

An example in which a PUSH transmission instruction to be canceled is designated by an identifier of URL form, and another PUSH transmission instruction is issued while canceling all segments scheduled to be PUSHed by the PUSH transmission instruction on HTTP/2 will be described next with reference to FIGS. 14A and 14B.

Reference numerals 1401 to 1404 in FIGS. 14A and 14B are the same as 801 to 804, and reference numerals 1405 to 1407 are the same as 806 to 808. In addition, the contents of steps S601 to S605 in FIG. 6 and steps S701 to S705 in FIG. 7 are the same as those in FIGS. 8A and 8B, and a description thereof will be omitted. As can be seen from the response 1403 shown in FIGS. 14A and 14B which does not include a description corresponding to 805 in FIGS. 8A and 8B, no identifier is assigned to the PUSH transmission instruction 1402 in FIGS. 14A and 14B, unlike FIGS. 8A and 8B. However, an identifier may be assigned as in FIGS. 8A and 8B.

In step S706, the communication unit 308 of the reception apparatus 102 transmits a request 1408 including a PUSH transmission cancel instruction 1410 in the accept-push-policy header to the transmission apparatus 101. The PUSH transmission cancel instruction 1410 has contents to cancel all segments scheduled to be PUSH-transmitted by the PUSH transmission instruction as the target. The PUSH transmission cancel instruction 1410 includes “/example/tmp/segmentA1” 1411 that is a URL designated when instructing the PUSH transmission instruction 1402 to designate the PUSH transmission instruction as the cancel target. In the example shown in FIGS. 14A and 14B, the URL 1411 is included together with a prefix “path” after the PUSH transmission cancel instruction 1410. The prefix is not limited to “path”. In addition, the prefix may be absent.

Another value capable of discriminating the PUSH transmission instruction may be included in place of the URL. Instead of designating the PUSH transmission instruction of the cancel target by the URL 1411, a segment to be canceled may be designated directly by a list form or a template form. When designating the cancel target by a list form, a cancel instruction representing a list form like “urn:sample:push-cancel-list” may be designated in 1410. Then, a form like “/example/tmp/segmentA3”;“/example/tmp/segmentA4”;“/example/tmp/segment A5”;“/example/tmp/segmentA6” is designated in place of 1411.

When designating the cancel target by a template form, a cancel instruction representing a template form like “urn: sample: push-cancel-templete” may be designated in 1410. Then, a form like “/example/tmp/segmentA{%d}; {3,4,5,6}” or “/example/tmp/segmentA{%d}; {3-6}” is designated in place of 1411.

The communication unit 308 of the reception apparatus 102 includes a PUSH transmission instruction 1412 to be newly set in the request 1408 in addition to the PUSH transmission cancel instruction. The PUSH transmission instruction 1412 is included after the PUSH transmission cancel instruction 1410 and 1411 in the accept-push-policy header. The PUSH transmission instruction 1412 may be included before the PUSH transmission cancel instruction 1410 and 1411. A URL 1409 serving as the base at the time of execution of the newly set PUSH transmission instruction 1412 is included in the path header. In the example shown in FIGS. 14A and 14B, the URL designated in the path header is “/example/tmp/segmentB3”, and a PUSH transmission instruction 1423 requests PUSH transmission of four continuous segments. Hence, the PUSH transmission instruction 1412 has contents to instruct PUSH transmission of four segments B4 to B7 continuing from segment B3 in terms of reproduction time.

The contents of the processes of steps S606 to S611 in FIG. 6 are the same as those described with reference to FIGS. 8A and 8B, and a description thereof will be omitted.

In step S612, the communication unit 207 of the transmission apparatus 101 transmits a response 1415 including a reply 1414 to the PUSH transmission cancel instruction 1410 and the PUSH transmission instruction 1412 in the push-policy header to the reception apparatus 102. The reply 1414 has the same contents as 1410, 1411, and 1412.

In step S707, the communication unit 308 of the reception apparatus 102 receives a response 1413 including the reply 1414 of the PUSH transmission cancel instruction 1410 and the PUSH transmission instruction 1412 and the binary data of segment B3.

For canceled segment A3, the transmission apparatus 101 has transmitted the PUSH_PROMISE 1406 to the reception apparatus 102. Hence, to cancel this, the transmission apparatus 101 transmits the RST_STREAM 1415, and the reception apparatus 102 receives this. The RST_STREAM 1415 may be transmitted by the reception apparatus 102 before step S706 or after step S707.

From step S612, the transmission apparatus 101 newly starts PUSH transmission based on the PUSH transmission instruction 1412. That is, the transmission apparatus 101 starts PUSH transmission of segment B4 to segment B7.

In Operation Example 7, an example in which a PUSH transmission instruction to be canceled is designated by an identifier, and another PUSH transmission instruction is issued while canceling all segments scheduled to be PUSHed by the PUSH transmission instruction has been described. In Operation Example 7 as well, the PUSH transmission instruction is designated by the identifier, thereby canceling PUSH transmission without needing extra transactions to specify the cancel target.

### Operation Example 8

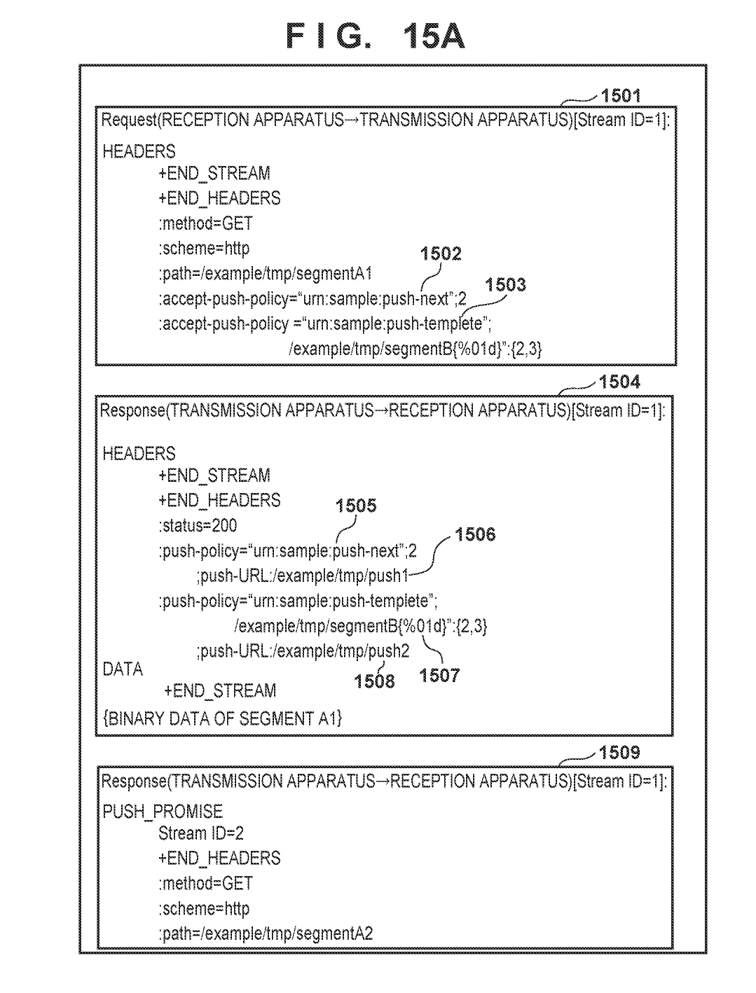

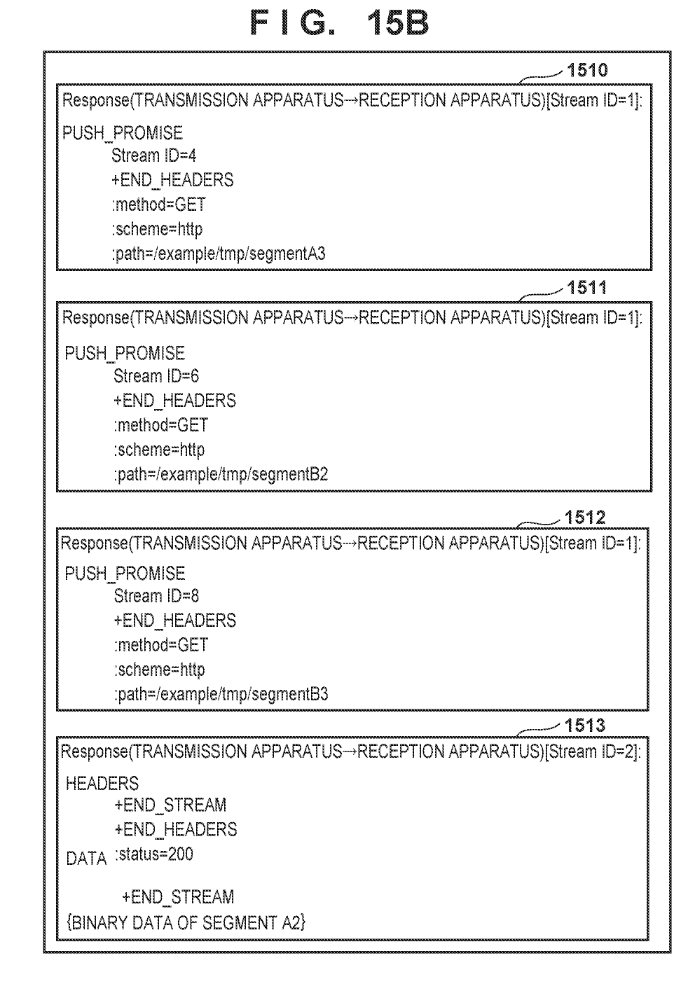

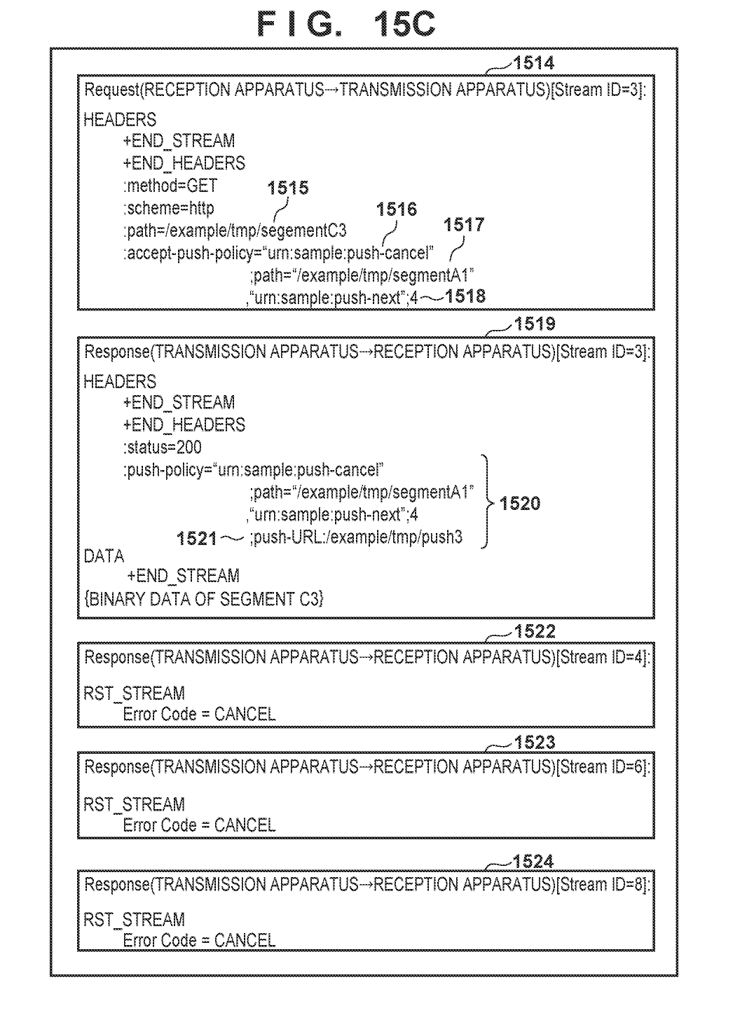

An example in which after a plurality of PUSH transmission instructions are requested and employed, all the PUSH transmission instructions are designated as cancel targets by an identifier of URL form, and all segments scheduled to be PUSH-transmitted by each PUSH transmission instruction are canceled on HTTP/2 will be described next. An example in which a new PUSH transmission instruction is issued in addition to this cancel will be described with reference to FIGS. 15A, 15B, and 15C.

In FIGS. 15A, 15B, and 15C, reference numerals 1501 to 1513 are the same as 1101 to 1113 in FIGS. 11A, 11B, and 11C. In addition, the contents of the processes of steps S601 to S605 in FIG. 6 and steps S701 to S705 in FIG. 7 are the same as the contents of processing described with reference to FIGS. 11A, 11B, and 11C and FIGS. 8A and 8B, and a description thereof will be omitted.

In step S706, the communication unit 308 of the reception apparatus 102 transmits a request 1514 including a PUSH transmission cancel instruction 1516 in the accept-push-policy header to the transmission apparatus 101. The PUSH transmission cancel instruction 1516 has contents to cancel all segments scheduled to be PUSH-transmitted by the PUSH transmission instruction of the target. The PUSH transmission cancel instruction 1516 includes “/example/tmp/segmentA1” 1517 that is a URL designated when instructing the PUSH transmission instructions 1502 and 1503 to designate the PUSH transmission instruction as the cancel target. When the URL 1517 is designated, all the PUSH transmission instructions that have issued the request by designating “/example/tmp/segmentA1” are set to the cancel targets. In FIGS. 15A, 15B, and 15C, not only segment A2 and segment A3 but also segment B2 and segment B3 are requested based on a path name “:path=/example/tmp/segmentA1”. That is, both the PUSH transmission instructions 1502 and 1503 use the same resource “segment A1”. For this reason, in the PUSH transmission cancel instruction 1516, both the PUSH transmission instructions 1502 and 1503 are the cancel targets.

The URL 1517 is included together with a prefix “path” after the PUSH transmission cancel instruction 1516. The prefix is not limited to “path”. In addition, the prefix may be absent. Another value capable of discriminating the PUSH transmission instruction may be included in place of the URL. Instead of designating the PUSH transmission instruction of the cancel target by the URL 1517, a segment to be canceled may be designated directly by a list form or a template form. The communication unit 308 of the reception apparatus 102 includes a PUSH transmission instruction 1518 to be newly set in the request 1514 in addition to the PUSH transmission cancel instruction. In the example shown in FIGS. 15A, 15B, and 15C, the PUSH transmission instruction 1518 is included after the PUSH transmission cancel instruction 1516 and 1517 in the accept-push-policy header. The PUSH transmission instruction 1518 may be arranged before the PUSH transmission cancel instruction 1516 and 1517. A URL 1515 serving as the base at the time of execution of the newly set PUSH transmission instruction 1518 is included in the path header. Since the URL designated in the path header is “/example/tmp/segmentC3”, the PUSH transmission instruction 1518 has contents to instruct PUSH transmission of four segments (C4 to C7) continuing from segment C3 in terms of reproduction time.

The contents of the processes of steps S606 to S611 in FIG. 6 are the same as those described with reference to FIGS. 8A and 8B, and a description thereof will be omitted.

In step S612, the communication unit 207 of the transmission apparatus 101 transmits a response 1519 including a reply 1520 to the PUSH transmission cancel instruction 1516 and the PUSH transmission instruction 1518 in the push-policy header to the reception apparatus 102. The reply 1520 has the same contents as the PUSH transmission cancel instructions 1516, 1517, and the PUSH transmission instruction 1518. The response 1519 includes the binary data of segment C3. In addition, the instruction management unit 206 of the transmission apparatus 101 assigns an identifier 1521 “/example/tmp/push3” to the received PUSH transmission instruction 1518. The identifier 1521 is included in the push-policy header of the response 1519. When a prefix “push-URL” is placed before the identifier 1521, the point of the push-policy header at which the identifier 1521 starts can be discriminated. The prefix is not limited to “push-URL”.

In step S707, the communication unit 308 of the reception apparatus 102 receives the response 1519 including the reply 1521 of the PUSH transmission cancel instruction 1516 and the PUSH transmission instruction 1518 from the transmission apparatus 101. For canceled segment A3, segment B2, and segment B3, the transmission apparatus 101 has transmitted PUSH_PROMISEs 1510 to 1512 to the reception apparatus 102. Hence, to cancel these, the transmission apparatus 101 transmits RST_STREAMs 1522 to 1524, and the reception apparatus 102 receives these. The RST_STREAMs 1522 to 1524 may be transmitted by the reception apparatus 102 before step S706 or after step S707.

From step S612, the transmission apparatus 101 newly starts PUSH transmission based on the PUSH transmission instruction 1518.

In Operation Example 8, an example in which after a plurality of PUSH transmission instructions are requested and employed, all the PUSH transmission instructions are designated as cancel targets by an identifier has been described. In Operation Example 8 as well, it is possible to cancel PUSH transmission without needing extra transactions to specify the cancel target.

### Operation Example 9

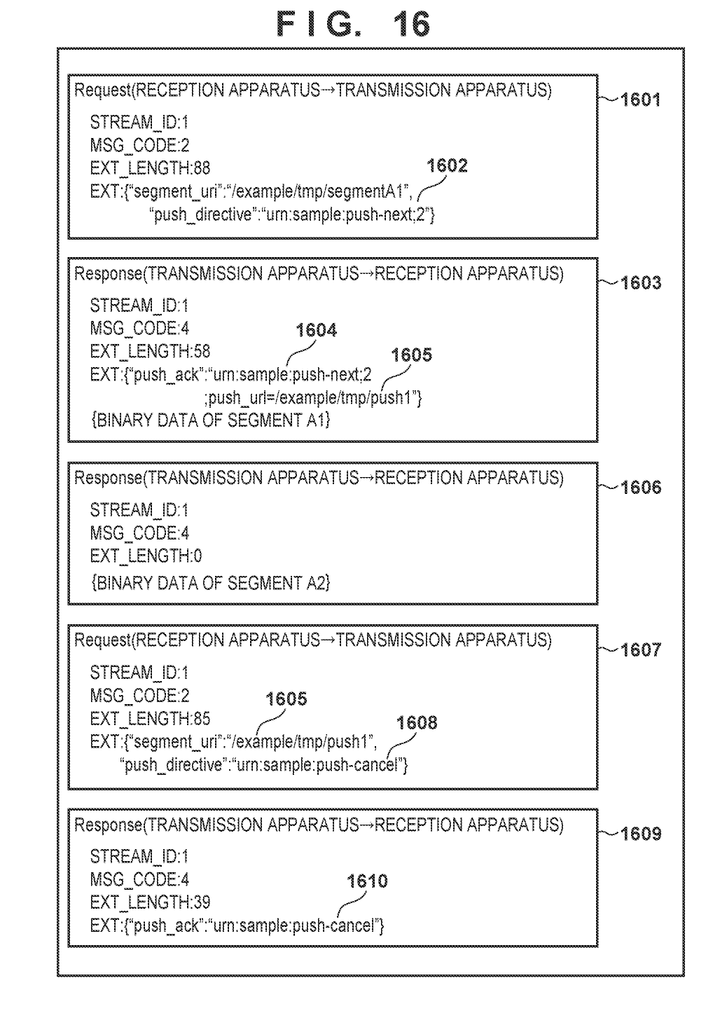

An example in which a PUSH transmission instruction to be canceled is designated by an identifier of URL form, and all segments scheduled to be PUSHed by the PUSH transmission instruction are canceled on Web Socket will be described next with reference to FIG. 16.

An identifier is assigned by the transmission apparatus 101, and the reception apparatus 102 skips the process of step S701.

In step S702, the communication unit 308 of the reception apparatus 102 transmits the request 1601 including a PUSH transmission instruction 1602 to the transmission apparatus 101. The PUSH transmission instruction includes a character string “urn:sample:push-next;2” after a prefix “push_directive”. The prefix is not limited to “push_directive”. The request 1601 is a message to request segment A1, and the PUSH transmission instruction 1602 instructs PUSH transmission of following two segments continuing from segment A1 in terms of reproduction time.

In step S601, the communication unit 207 of the transmission apparatus 101 receives the request 1601 including the PUSH transmission instruction 1602 from the reception apparatus 102.

In step S602, the instruction management unit 206 of the transmission apparatus 101 assigns an identifier 1605 “/example/tmp/push1” to the received PUSH transmission instruction 1602. In the example shown in FIG. 16, the identifier employs the form of a URL.

In step S603, the communication unit 207 of the transmission apparatus 101 transmits a response 1603 including a reply 1604 to the PUSH transmission instruction 1602 and the binary data of segment A1 to the reception apparatus 102. The reply 1604 has the same contents as the PUSH transmission instruction 1602. The reply 1604 of the PUSH transmission instruction is included after a prefix “push_ack”. The prefix is not limited to “push_ack”. The identifier 1605 is included in correspondence with a reply 1606 of the PUSH transmission instruction. The identifier 1605 is included after a prefix “push url=”. The prefix is not limited to “push url=”.

In step S604, the instruction management unit 206 of the transmission apparatus 101 holds the received PUSH transmission instruction 1602 and the identifier 1605 by linking them with each other.

In step S703, the communication unit 308 of the reception apparatus 102 receives the response 1603 including the reply 1604 of the PUSH transmission instruction 1602.

In step S704, the instruction management unit 306 of the reception apparatus 102 holds the PUSH transmission instruction 1602 accepted whose reply is returned and accepted by linking it with the identifier 1605.

In step S605, the transmission apparatus 101 starts PUSH transmission, and the communication unit 207 of the transmission apparatus 101 transmits a response 1606 including the binary data of segment A2 to the reception apparatus 102.

In step S705, the communication unit 308 of the reception apparatus 102 receives the response 1606.

In step S706, the communication unit 308 of the reception apparatus 102 transmits, as a request 1607, a PUSH transmission cancel instruction 1608 for all segments scheduled to be PUSH-transmitted by the PUSH transmission instruction 1602. The PUSH transmission target to be canceled is designated by designating the identifier 1605. The identifier 1605 is placed after a prefix “segment_uri”. The prefix is not limited to “segment_uri”.

In step S606, the communication unit 207 of the transmission apparatus 101 receives the request 1607 including the PUSH transmission cancel instruction 1608 from the reception apparatus 102.

In step S607, the instruction management unit 206 of the transmission apparatus 101 specifies, as a cancel candidate segment, segment A3 that is one of segments scheduled to be PUSHed by the PUSH transmission instruction 1602 that is the cancel target determined based on the identifier 1605. Since any PUSH transmission instruction other than the PUSH transmission instruction 1602 is not instructed in the transmission apparatus 101, step S608 is skipped, and the process transitions to step S609.

In step S609, the instruction management unit 206 of the transmission apparatus 101 outputs, to the segment decision unit 205, an instruction to cancel PUSH transmission of segment A3, and the segment decision unit 205 cancels the PUSH transmission of segment A3.

In step S610, it is determined that confirming whether cancel is possible and cancel processing are performed for all the cancel candidate segments of the PUSH transmission instruction 1602 by the PUSH transmission cancel instruction 1608 (YES in step S610), and the process transitions to step S611.

In step S611, since the PUSH transmission instruction of the cancel target is only the PUSH transmission instruction 1602 (YES in step S611), the process transitions to step S612.

In step S612, the communication unit 207 of the transmission apparatus 101 transmits a response 1609 including a reply 1610 to the PUSH transmission cancel instruction 1608 to the reception apparatus 102. The reply 1610 has the same contents as the PUSH transmission cancel instruction 1608. The reply 1610 of the PUSH transmission cancel instruction is placed after a prefix “push_ack”. The prefix is not limited to “push_ack”.

In step S707, the communication unit 308 of the reception apparatus 102 receives the response 1609 including the reply 1610 of the PUSH transmission cancel instruction from the transmission apparatus 101.

In Operation Example 9, a description concerning HTTP/2 and Web Socket has been made. This embodiment can also be applied to QUIC and any other protocol having the PUSH function.

### Operation Example 10

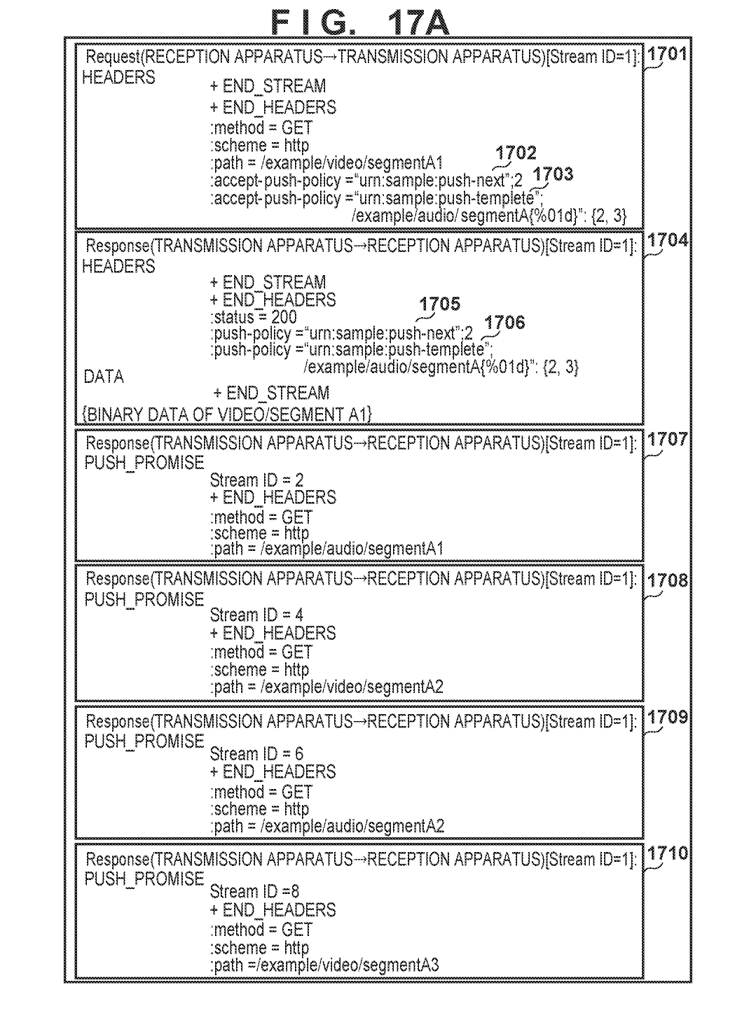

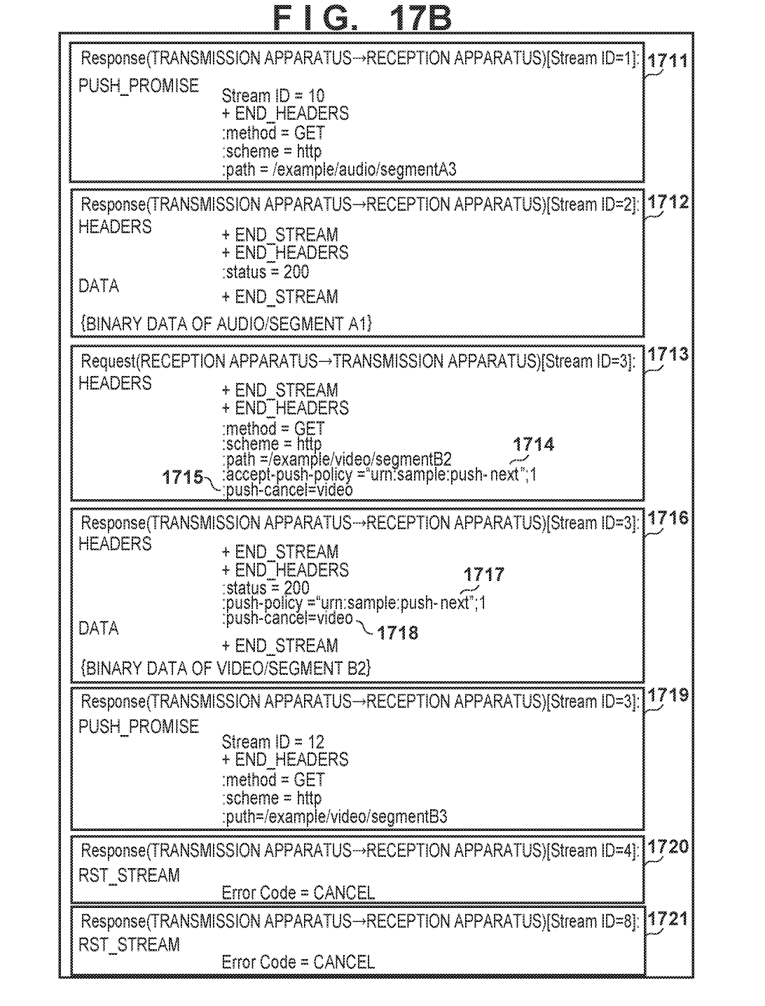

An example in which after a PUSH transmission instruction is requested, PUSH transmission cancel and a new PUSH transmission instruction are simultaneously performed on HTTP/2 will be described with reference to FIGS. 17A and 17B. In this example, since the type of data of a segment is used as an identifier, step S701 in which the reception apparatus 102 assigns an identifier to a PUSH transmission instruction is skipped. Additionally, in this example, a video data segment is represented by “/example/video/”+segment name, and a segment of audio data is represented by “/example/audio/”+segment name.

In step S702, the communication unit 308 of the reception apparatus 102 transmits a request 1701 including PUSH transmission instructions 1702 and 1703 in the accept-push-policy header to the transmission apparatus 101. The PUSH transmission instructions 1702 and 1703 may be included not in separate accept-push-policy headers but in one accept-push-policy header. In 1702, a number “2” next to “urn:sample:push-next” designates the number of segments to be acquired next to “/example/vdeso/segmentA1”. Hence, the reception apparatus 102 requests PUSH transmission of video/segment A2 and video/segment A3 by the PUSH transmission instruction 1702. Additionally, in 1703, two numbers in parentheses next to “/example/audio/segmentA(%01d)” specify segments of request targets by the range of values that “(%01d)” can take. In the example of 1703, since “{2,3}” is designated as the range, the PUSH transmission instruction 1703 requests PUSH transmission of audio/segment A2 and audio/segment A3.

In step S601, the communication unit 207 of the transmission apparatus 101 receives the request 1701 including the PUSH transmission instructions 1702 and 1703.

In Operation Example 10, since the type of data of a segment is used as an identifier, the transmission apparatus 101 skips the process of step S602.

In step S603, the communication unit 207 of the transmission apparatus 101 transmits a response 1704 including replies to the PUSH transmission instructions 1702 and 1703 in the push-policy headers to the reception apparatus 102. The response 1704 also includes the binary data of video/segment A1. In Operation Example 10, replies 1705 and 1706 of the PUSH transmission instructions having the same contents as the PUSH transmission instructions 1702 and 1703 are included in the response 1704 as the replies to the PUSH transmission instructions 1702 and 1703. That is, the response 1704 includes two push-policy headers, and includes the replies 1705 and 1706 of the PUSH transmission instructions by the two headers. Note that the replies 1705 and 1706 of the PUSH transmission instructions may be included not in separate push-policy headers but in one push-policy header.

After transmission of the response 1704, for segments scheduled to be PUSH-transmitted on HTTP/2, the transmission apparatus 101 transmits PUSH_PROMISEs 1707 to 1711 that reserve streams to be used to transmit the segments to the reception apparatus 102. The reception apparatus 102 receives the PUSH_PROMISEs 1707 to 1711 from the transmission apparatus 101. The PUSH_PROMISEs 1707, 1708, 1709, 1710, and 1711 may be transmitted/received before the response 1704.

In Operation Example 10, since the type of data of a segment is used as an identifier, the transmission apparatus 101 skips the process of step S604.

In step S703, the communication unit 308 of the reception apparatus 102 receives the response 1704 including the reply 1705 to the PUSH transmission instruction 1702 and the reply 1706 to the PUSH transmission instruction 1703.

In step S704, the instruction management unit 306 of the reception apparatus 102 holds the PUSH transmission instructions 1702 and 1703 whose replies are returned and accepted. Note that in Operation Example 10, the plurality of PUSH transmission instructions are exchanged by a set of a request and a response. However, the PUSH transmission cancel processing according to this embodiment can also be executed by a method of exchanging a request and a response for each PUSH transmission instruction.

In step S605, the transmission apparatus 101 starts PUSH transmission, and the communication unit 207 of the transmission apparatus 101 transmits a response 1712 including the binary data of audio/segment A1 to the reception apparatus 102 as the PUSH transmission of audio/segment A1.

In step S705, the communication unit 308 of the reception apparatus 102 receives the response 1712.

In step S706, the communication unit 308 of the reception apparatus 102 transmits a request 1713 including a PUSH transmission cancel instruction 1715 and a PUSH transmission instruction 1714. In this embodiment, a push-cancel header is used as the PUSH transmission cancel instruction 1715. However, a header having a name different from push-cancel may be used as the cancel instruction. In Operation Example 10, a segment of video data is set to the PUSH transmission cancel target, and a value “video” is designated as the value of the push-cancel header 1715 to instruct the PUSH transmission cancel target. However, a value different from “video” may be used. In addition, a segment other than a video data segment, for example, a segment of audio data or metadata may be set to the PUSH transmission cancel target by designating a value “audio” or “metadata”. The type of data of a segment may specifically be designated to a codec name, the language of an audio, or the like. All segments may be set to the PUSH transmission cancel targets by designating “immediate” or the like. As the value used to instruct the PUSH cancel target, an ID of AdaptationSet or Representation may be used in place of a character string representing the type of data such as “video”. In the PUSH transmission instruction 1714, a number “1” next to “urn:sample:push-next” designates the number of segments to be acquired next to “/example/tmp/segmentB2”. Hence, the reception apparatus 102 requests PUSH transmission of video/segment B3 by the PUSH transmission instruction 1714.

In step S606, the communication unit 207 of the transmission apparatus 101 receives the request 1713 including the PUSH transmission cancel instruction 1715 and the PUSH transmission instruction 1714 from the reception apparatus 102. The push transmission instruction 1702 of the cancel target is specified based on the reception apparatus that has transmitted the request 1713 including the cancel instruction 1715 and the type of data (video in this example) included in the cancel instruction 1715.

In step S607, the instruction management unit 206 of the transmission apparatus 101 specifies, as a cancel candidate segment, one of the segments scheduled to be PUSHed by the PUSH transmission instruction 1702 based on the value of the PUSH transmission cancel instruction 1715. In this example, since the segments scheduled to be PUSHed by the PUSH transmission instruction 1103 are video/segment A2 and video/segment A3, video/segment A2 that is one of the segments is specified as the cancel candidate segment.

In step S608, it is determined that video/segment A2 as the cancel candidate segment is not the PUSH transmission target by the PUSH transmission instruction 1703 employed by the transmission apparatus 101 in addition to the PUSH transmission instruction 1702 (NO in step S608), and the process transitions to step S609.

In step S609, the instruction management unit 206 of the transmission apparatus 101 outputs, to the segment decision unit 205, an instruction to cancel PUSH transmission of video/segment A2, and the segment decision unit 205 cancels the PUSH transmission of video/segment A2. As detailed cancel processing, since the transmission is already reserved by the PUSH_PROMISE 1708, transmission of an RST_STREAM 1719 used to cancel the transmission reservation and processing of stopping PUSH transmission in the transmission apparatus 101 are performed.

In step S610, it is determined that confirming whether cancel is possible and cancel processing are not performed for all the cancel candidate segments of the PUSH transmission instruction 1702 by the PUSH transmission cancel instruction 1715 (NO in step S610). This is because the processing is not performed for video/segment A3 in the segments scheduled to be PUSHed. Hence, the process transitions to step S607.

In step S607, the instruction management unit 206 of the transmission apparatus 101 specifies, as a cancel candidate segment, video/segment A3 that is one of segments scheduled to be PUSHed by the PUSH transmission instruction 1702 that is the cancel target determined based on the value of the PUSH transmission cancel instruction 1715.

In step S608, it is determined that video/segment A3 that is the cancel candidate segment is not the PUSH transmission target of the PUSH transmission instruction 1703 employed by the transmission apparatus 101 in addition to the PUSH transmission instruction 1702 (NO in step S608), and the process transitions to step S609.

In step S609, the instruction management unit 206 of the transmission apparatus 101 outputs, to the segment decision unit 205, an instruction to cancel PUSH transmission of video/segment A3, and the segment decision unit 205 cancels the PUSH transmission of video/segment A3. As detailed cancel processing, since the transmission is already reserved by the PUSH_PROMISE 1710, transmission of an RST_STREAM 1721 used to cancel the transmission reservation and processing of stopping PUSH transmission in the transmission apparatus 101 are performed.

In step S610, it is determined that confirming whether cancel is possible and cancel processing are performed for all the cancel candidate segments of the PUSH transmission instruction 1702 by the PUSH transmission cancel instruction 1715 (YES in step S610), and the process transitions to step S611.

In step S611, since the PUSH transmission instruction of the cancel target is only the PUSH transmission instruction 1702 (YES in step S611), the process transitions to step S612.

In step S612, the communication unit 207 of the transmission apparatus 101 transmits a response 1716 including a reply 1718 to the PUSH transmission cancel instruction 1715 and a reply 1717 to the PUSH transmission instruction 1714 to the reception apparatus 102. The reply 1718 to the PUSH transmission cancel instruction 1715 uses the push-cancel header, and has the same contents as the PUSH transmission cancel instruction 1715. Note that another header may be used. The response 1717 also includes the binary data of video/segment B2.

In step S707, the communication unit 308 of the reception apparatus 102 receives the response 1716 including the reply 1718 to the PUSH transmission cancel instruction 1715 and the reply 1717 to the PUSH transmission instruction 1714.

After transmission of the response 1716, for segments scheduled to be PUSH-transmitted on HTTP/2, the transmission apparatus 101 transmits a PUSH_PROMISE 1719 that reserves streams to be used to transmit the segments to the reception apparatus 102. The reception apparatus 102 receives the PUSH_PROMISE 1719 from the transmission apparatus 101.

For canceled video/segment A2 and video/segment A3, the transmission apparatus 101 has already transmitted the PUSH_PROMISEs 1708 and 1710 to the reception apparatus 102. Hence, these need to be canceled. To do this, the transmission apparatus 101 transmits the RST_STREAMs 1720 and 1721 to the reception apparatus 102, and the reception apparatus 102 receives them. The RST_STREAMs 1720 and 1721 may be transmitted by the reception apparatus 102 before step S706 or after step S707.

In Operation Example 10, an example in which the PUSH transmission cancel instruction 1715 and the PUSH transmission instruction 1714 are performed together has been described. Since the PUSH transmission cancel instruction 1715 and the PUSH transmission instruction 1714 can be transmitted by the sane request, resetting of the PUSH transmission instruction can be performed without needing extra transactions. In addition, since the type of data of a segment can be designated, PUSH transmission cancel and PUSH transmission resetting for only a specific type of segment can easily be performed. As an example, in a case in which video segments and audio segments are PUSH targets, it is possible to cancel PUSH transmission of only the video segments without canceling the audio segments and perform resetting of PUSH transmission of video segments of different resolutions.

As described above, according to this embodiment, it is possible to cancel PUSH transmission by a small number of transactions between the transmission apparatus 101 and the reception apparatus 102. Additionally, in a case in which a plurality of PUSH transmission instructions are sent, and only some PUSH transmission instructions are to be canceled or in a case in which only some segments scheduled to be PUSH-transmitted are to be canceled, the reception apparatus 102 can perform the cancel by transmitting one request. Furthermore, when MPEG-DASH is transmitted/received on HTTP/2, and the reception apparatus 102 instructs to cancel PUSH transmission, segments that are not transmission-reserved by a PUSH_PROMISE need not individually be canceled. It is therefore possible to save the band on the network.

According to the present invention, it is possible to cancel a reservation concerning push transmission by a small number of transactions.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A server apparatus comprising:
a reception unit configured to receive, from a client apparatus, a push transmission instruction concerning a media segment whose content data is divided;
a transmission unit configured to push-transmit a media segment according to the push transmission instruction received by the reception unit to the client apparatus; and
a control unit configured to, in a case in which a push cancel instruction including identification information used by the server apparatus to specify a media segment whose push transmission by the transmission unit is to be canceled in media segments according to the push transmission instruction received by the reception unit is received from the client apparatus, cancel push transmission of the media segment specified based on the identification information by the transmission unit.

2. The server apparatus according to claim 1, wherein the identification information includes a URL, and
the control unit cancels push transmission of a media segment specified based on the URL by the transmission unit.

3. The server apparatus according to claim 1, wherein the push cancel instruction received by the reception unit is included in a header of a message from a web browser executed in the client apparatus.

4. The server apparatus according to claim 1, wherein the identification information includes an identifier used to identify the push transmission instruction, and
the control unit cancels push transmission of a media segment specified based on the identifier by the transmission unit.

5. The server apparatus according to claim 4, wherein the identifier is assigned by the client apparatus and described in the push transmission instruction received by the reception unit.

6. The server apparatus according to claim 4, further comprising an assignment unit configured to assign the identifier to the push transmission instruction in accordance with reception of the push transmission instruction by the reception unit,
wherein the transmission unit notifies the client apparatus of the identifier assigned by the assignment unit.

7. The server apparatus according to claim 1, wherein the identification information includes time information concerning the push transmission instruction, and
the control unit cancels push transmission of a media segment specified based on the time information by the transmission unit.

8. The server apparatus according to claim 7, wherein the time information is time information concerning a transmission time of the push transmission instruction by the client apparatus.

9. The server apparatus according to claim 7, wherein the time information is time information concerning a transmission time of a response to the push transmission instruction from the client apparatus.

10. The server apparatus according to claim 1, wherein the identification information includes type information of media data, and
the control unit cancels push transmission of a media segment specified based on the type information by the transmission unit.

11. The server apparatus according to claim 10, wherein the type information is information used to at least make a discrimination between video data, audio data, and other data.

12. The server apparatus according to claim 1, wherein in a case in which the push cancel instruction including information that designates cancel of all push transmissions is received from the client apparatus, the control unit cancels all push transmissions concerning the media segment by the transmission unit.

13. The server apparatus according to claim 1, wherein the control unit
does not cancel push transmission of a media segment corresponding to another push transmission instruction received by the reception unit in one or a plurality of media segments corresponding to the push transmission instruction designated by the push cancel instruction, and
cancels push transmission of a media segment that does not correspond to the other push transmission instruction in the one or the plurality of media segments corresponding to the push transmission instruction designated by the push cancel instruction.

14. The server apparatus according to claim 1, wherein in a case in which a push cancel instruction that designates a plurality of push transmission instructions is received from the client apparatus, the control unit cancels push transmission of a plurality of media segments according to the plurality of push cancel instructions by the transmission unit.

15. The server apparatus according to claim 1, wherein the identification information is described in MPD (Media Presentation Description).

16. A client apparatus comprising:
a transmission unit configured to transmit, to a server apparatus, a push transmission instruction concerning a media segment whose content data is divided;
a reception unit configured to receive a media segment push-transmitted from the server apparatus in accordance with the push transmission instruction transmitted by the transmission unit; and
a control unit configured to transmit, to the server apparatus, a push cancel instruction including identification information used by the server apparatus to specify a media segment whose push transmission by the server apparatus is to be canceled in media segments according to the push transmission instruction transmitted to the server apparatus by the transmission unit, thereby canceling push transmission of the media segment according to the identification information by the server apparatus.

17. A method of controlling a server apparatus, comprising:
receiving, from a client apparatus, a push transmission instruction concerning a media segment whose content data is divided;
push-transmitting a media segment according to the push transmission instruction received from the client apparatus to the client apparatus in a case in which a push cancel instruction including identification information used by the server apparatus to specify a media segment whose push transmission is to be canceled in media segments according to the push transmission instruction received from the client apparatus is not received from the client apparatus; and
inhibiting push transmission of an untransmitted media segment specified based on the identification information in a case in which the push cancel instruction including the identification information used by the server apparatus to specify the media segment whose push transmission is to be canceled in the media segments according to the push transmission instruction received from the client apparatus is received from the client apparatus.

18. A method of controlling a client apparatus, comprising:
transmitting, to a server apparatus, a push transmission instruction concerning a media segment whose content data is divided; and
transmitting, to the server apparatus, a push cancel instruction including identification information used by the server apparatus to specify a media segment whose push transmission by the server apparatus is to be canceled in media segments according to the push transmission instruction transmitted to the server apparatus, thereby canceling push transmission of the media segment according to the identification information by the server apparatus.

19. A non-transitory computer-readable storage medium storing a program for causing a computer to perform a method of controlling a server apparatus, the method comprising:
receiving, from a client apparatus, a push transmission instruction concerning a media segment whose content data is divided;
push-transmitting a media segment according to the push transmission instruction received from the client apparatus to the client apparatus in a case in which a push cancel instruction including identification information used by the server apparatus to specify a media segment whose push transmission is to be canceled in media segments according to the push transmission instruction received from the client apparatus is not received from the client apparatus; and
inhibiting push transmission of an untransmitted media segment specified based on the identification information in a case in which the push cancel instruction including the identification information used by the server apparatus to specify the media segment whose push transmission is to be canceled in the media segments according to the push transmission instruction received from the client apparatus is received from the client apparatus.

20. A non-transitory computer-readable storage medium storing a program for causing a computer to perform a method of controlling a client apparatus, the method comprising:
transmitting, to a server apparatus, a push transmission instruction concerning a media segment whose content data is divided; and
transmitting, to the server apparatus, a push cancel instruction including identification information used by the server apparatus to specify a media segment whose push transmission by the server apparatus is to be canceled in media segments according to the push transmission instruction transmitted to the server apparatus, thereby canceling push transmission of the media segment according to the identification information by the server apparatus.
